(19) United States
(12) Patent Application Publication
(10) Pub. No.: US 2008/0059256 A1
(43) Pub. Date: Mar. 6, 2008

(54) Event Management and Marketing System

(76) Inventor: Kevin Maurice Lynch, San Ramon, CA (US)

Correspondence Address: Kevin Lynch, 4191 Reedland Circle, San Ramon, 94582, omitted

(21) Appl. No.: 11/458,665

(22) Filed: Jul. 19, 2006

(51) Int. Cl. G06F 17/50

(52) U.S. Cl. 705/7

(57) ABSTRACT

An event management and marketing system is provided. In one implementation, the event management and marketing system includes a planning module to receive user input entering a name of an event, and a marketing module to present to the user a plurality of different marketing strategies for marketing the event; receive user input selecting one or more of the of different marketing strategies; and generate an output corresponding to each marketing strategy selected by the user, each respective output to be used in execution of the corresponding marketing strategy.

### FIELD OF THE INVENTION

The present invention relates generally to event management and marketing.

### BACKGROUND Of THE INVENTION

Conventional event management systems typically include features that enable a user (e.g., an event coordinator) to plan an event—e.g., a seminar, conference, or other type of event. For example, EventPro® planner available from EventPro Software of Saskatoon, Canada permits a user to plan logistics of an event such as registration details, travel arrangements, accommodations, communications, budgets, and so on. Likewise, event, available from Cvent, Inc. of McLean, Va., permits a user to plan logistics associated with an event, including: marketing the event through e-mail. While event permits a user to market an event through e-mail, event (along with other conventional event management systems), however, provides limited marketing strategies, if any, to a user to enable the user to more effectively promote and market an event.

### BRIEF SUMMARY OF THE INVENTION

In general, in one aspect, this specification describes an event management and marketing system. In one implementation, the event management and marketing system includes a planning module to receive user input entering a name of an event, and a marketing module to present to the user a plurality of different marketing strategies for marketing the event; receive user input selecting one or more of the of different marketing strategies; and generate an output corresponding to each marketing strategy selected by the user, each respective output to be used in execution of the corresponding marketing strategy.

Particular features can include one or more of the following features. The marketing module can further be operable to provide a tutorial to the user, in which the tutorial includes information corresponding to each marketing strategy. The tutorial provides detail to enable a user to determine whether a given market strategy would be effective in marketing an event. The output of the marketing module can be in a form of at least one of a plan of execution, an e-mail, an advertisement, an admission ticket. The event management and marketing system can further include a fundraising module to provide a plurality of different fundraising strategies to the user for raising capital to fund the event. The planning module can warn the user of calendar days to avoid scheduling an event. The planning module can maintain a weather outlook for days during which the event is planned.

In general, in another aspect, this specification describes a computer program product, tangibly stored on a computer-readable medium, for marketing an event. The product contains instructions for causing a programmable processor to: receive user input entering a name of an event; present to the user a plurality of different marketing strategies for marketing the event; receive user input selecting one or more of the of different marketing strategies; and generate an output corresponding to each marketing strategy selected by the user. Each respective output is to be used in execution of the corresponding marketing strategy.

The details of one or more implementations are set forth in the accompanying drawings and the description below. Other features and advantages will be apparent from the description and drawings.

### BRIEF DESCRIPTION OF THE DRAWINGS

FIG. 1 illustrates a block diagram of an event management and marketing system.

FIG. 2 illustrates a method for marketing an event using the event management and marketing system of FIG. 1.

Like reference symbols in the various drawings indicate like elements.

### DETAILED DESCRIPTION OF THE INVENTION

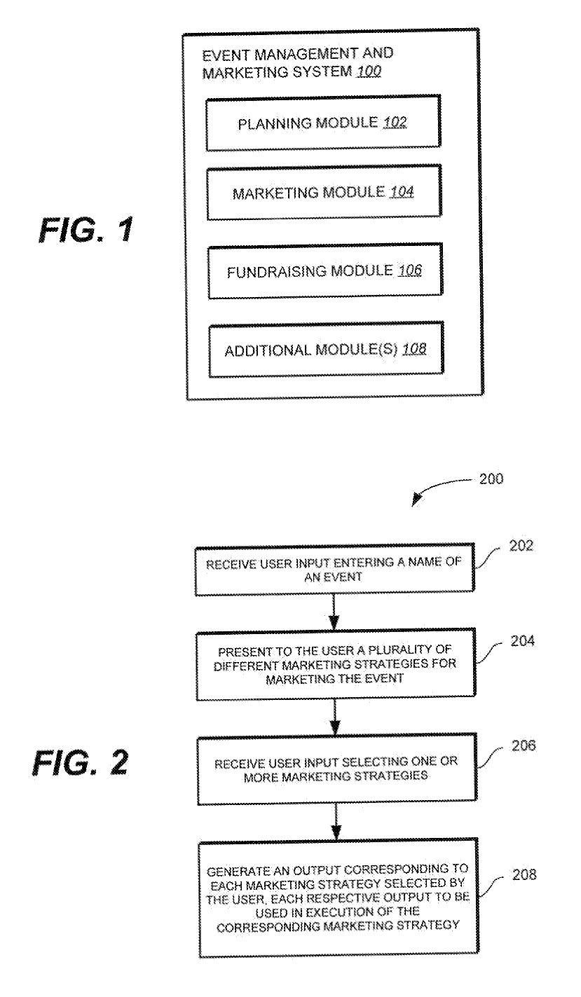

FIG. 1 shows an event management and marketing system 100. In one implementation, the event management and marketing system 100 includes a planning module 102, a marketing module 104, a fundraising module 106, and one or more additional module(s) 108. The event management and marketing system 100 can be implemented within a data processing system—e.g., a single computer system (such as a desktop, or laptop computer) or can be implemented throughout a network of computers (such as the Internet).

The planning module 102 permits a user to generally plan logistics of an event—e.g., to develop a project plan. In one implementation, the planning module presents one or more graphical user interfaces to a user so that the user can enter logistics associated with an event into the event management and marketing system 100. For example, in one implementation, the planning module permits a user to do the following with regard to an event: establish a scope and purpose, establish a logo and/or theme, set up a timeline, develop a website, select staff and other resources, determine risks and contingency plans, develop a game plan, and so on. In one implementation, the planning module warns the user of calendar days (e.g., holidays) to avoid scheduling an event. In one implementation, the planning module 102 informs the user of the weather outlook for the days during which an event is planned. Accordingly, the planning module 102 permits a user to take into account the weather in planning an event. An example of a project plan is provided below.

The marketing module 104 permits a user to market an event. In one implementation, the marketing module 104 presents to a user a plurality of different marketing strategies for marketing an event. Examples of different marketing strategies are discussed in greater detail below. In one implementation, the marketing module 104 presents each marketing strategy to the user through a graphical user interface. In one implementation, the marketing module 104 provides a tutorial for each marketing strategy presented to the user. The tutorial on the different marketing strategies provides a user with the necessary information required to make an appropriate marketing strategy that is tailored to an event. In one implementation, the graphical user interface includes a radio button located next to a respective marketing strategy for selection by user using a mouse, or other input device. In response to receiving user input selecting one or more marketing strategies, the marketing module (in one implementation) generates an output corresponding to a given marketing strategy for use in implementing or executing the marketing strategy. The output can take a variety of forms—such as a plan of execution (for the marketing strategy), an e-mail, aft advertisement, an admission ticket, and so on. In general, the output is related to the corresponding marketing strategy. Possible outputs for various marketing strategies are discussed in greater detail below.

The fundraising module 106 permits a user to raise funds for an event. In one implementation, the fundraising module 106 maintains a budget of production expenses and revenue that permits a user to project a net income for an event. In one implementation, the fundraising module 106 presents one or more fundraising strategies to the user. Examples different fundraising strategies are discussed in greater detail below. The fundraising module 106 helps a user in appropriately raising sufficient capital for an event. The event management and marketing system 106 can further include one or more additional modules for performing additional functions as discussed below.

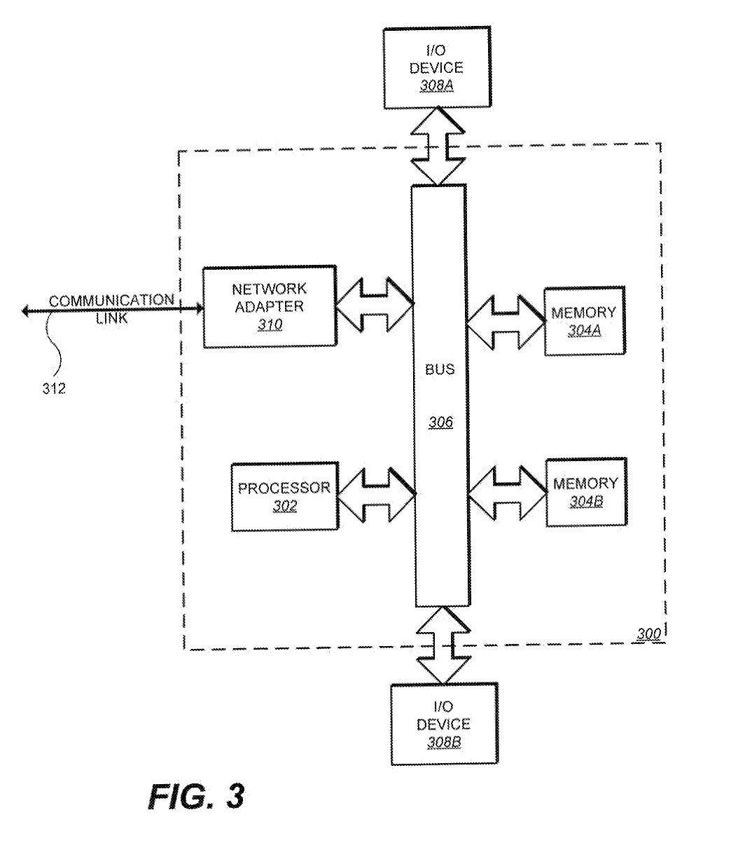

FIG. 2 shows a method 200 for marketing an event. User input is received entering a name of an event (step 202). The user input can be received through a graphical user interface (e.g., a web browser, or other application screen). A plurality of different marketing strategies for marketing the event is presented to the user. The different marketing strategies can be presented to the user through a graphical user interface. In one implementation, a tutorial for each different marketing strategy is available to the user. In one implementation, the tutorial provides a step-by-step implementation of each marketing strategy along with the pros and cons of each marketing strategy. In one implementation, the user can activate a tutorial corresponding to a given marketing by selecting the tutorial though a dialog box, drop-down window, or clicking on an icon corresponding to the tutorial (e.g., a question mark icon located next to a name of the marketing strategy). The available tutorial on various marketing strategies provides a great advantage over conventional event management systems, in that the tutorial enables a user to more effectively select one or more marketing strategies that are appropriate for a given event. User input is received selecting one or more of the different marketing strategies is received (step 206). An output is generated corresponding to each marketing strategy selected by the user (step 208). In one implementation, the generated output is used in execution of the corresponding marketing strategy. The output can take a variety of forms—e.g., a timeline, a plan of execution, an admission ticket, a flyer, an e-mail, and so on.

FIG. 3 illustrates a data processing system 300 suitable for storing and/or executing program code (e.g., the steps of the methods discussed above). Data processing system 300 includes a processor 302 coupled to memory elements 304A-B through a system bus 306. In other implementations, data processing system 300 may include more than one processor and each processor may be coupled directly or indirectly to one or more memory elements through a system bus.

Memory elements 304A-B can include local memory employed during actual execution of the program code, bulk storage, and cache memories that provide temporary storage of at least some program code in order to reduce the number of times the code must be retrieved from bulk storage during execution. As shown, input/output or I/O devices 308A-B (including, but not limited to, keyboards, displays, pointing devices, etc.) are coupled to data processing system 300. I/O devices 308A-B may be coupled to data processing system 300 directly or indirectly through intervening I/O controllers (not shown). In one implementation, a network adapter 310 is coupled to data processing system 300 to enable data processing system 300 to become coupled to other data processing systems or remote printers or storage devices through communication link 312. Communication link 312 can be a private or public network. Modems, cable modems, and Ethernet cards are just a few of the currently available types of network adapters.

Sample Project Plan

Below is provided a sample project plan that can be created through the planning module 102 (FIG. 1). In one implementation, the planning module 102 permits a user to create such a project plan in a step-by-step automated manner. In addition, a seminar planning guide follows the sample project plan. In one implementation, the event management and marketing system 100 ensures that logistics (as detailed in the seminar planning guide) are considered by a user in planning an event. In one implementation, the event management and marketing system 100 generates a plurality of user interface screens to receive information from a user regarding such logistics.

Project Charter/Business Strategy
Table of Contents

| | |
|---|---|
| Title | Page 1 |
| Description/Purpose | Page 1 |
| Scope Statement | Page 1 |
| Objectives | Page 1 |
| Key Deliverables | Page 2 |
| Assumptions/Constraints | Page 2 |
| Key Staff/Resources | Page 2 |
| Risk & Contingency Plans | Page 3 |
| Success Criteria | Page 3 |
| Key Milestones/General Game Plan | Page 4 |
| Market Research/Systems | Page 5 |
| Strategy/Tactics | Page 6 |
| Work Breakdown Structure/Task List | Pages 7–9 |
| Timeline | Page 10 |
| Marketing Strategy | Page 11 |
| Budget | Pages 12–13 |
| Demographics | Page 15–17 |
| Written Authorization | Appendix - TBD |
| Sponsorship Proposal | Appendix - TBD |

### The “Millionaire Marketing & Wealth” Seminar

### Project Charter/Business Strategy

Description/How Guest Will Benefit:
The landscape of business has changed over the last 5 years. Just being aggressive doesn't, cut it anymore. Sales skills alone are not enough to succeed. It is imperative that Businesses distinguish themselves from the competition.
Businesses and organizations continue to use old, outdated, and antiquated Marketing tools and processes to generate leads, referrals, and profits. Knowing how to get customers, clients or patients is infinitely more important than years past!
“Even The Greatest Business Owners in the World Would Be Broke without a Constant Stream of constant paying clients and profits!”

Scope/Purpose Statement:

The purpose of The “Millionaire Marketing & Wealth Seminar” is to use Business Seminars, Marketing, Networking, and Motivational. Speaking as a vehicle to increase profits for local businesses and organizations, and to enhance the social and economic condition or our community for humanity as a whole!

Theme: “Critical Factors for Achieving Business & Marketing Success”

Total costs of the event will not exceed the total budget. Sponsorship and partnerships will be secured through out the San Francisco Bay Area beginning Jun. 1, 2006.

Objectives:
1. Set the event dates and locations by Jun. 1, 2006.
2. Ensure that total cost will not exceed Project/Event Budget of $66,056,
3. Host event at Venue in San Francisco Bay Area.
4. Have ticket sales occur by Jun. 3, 2006.
5. Develop Website and Marketing Campaign for Event by Jun. 1, 2006.
6. Have Event Flyers completed by Jun. 15, 2006.
7. Complete Itinerary complete and expenses paid by Jul. 21, 2006.
8. Earn $5,000+ in revenue from local sponsor by Jul. 1, 2006
9. Have 100 pre-registered guest 6 weeks prior to Aug. 8, 2006
10. Complete Sales Copy and Affiliate Links completed by May 15, 2006

Key Deliverables:
1. Project Charter/Game Plan completed by Jun. 1, 2006.
2. Budget (Revenue, Fees, Expenses, ROI Projections) by Jun. 1, 2006.
3. List of Confirmed Sponsors (Platinum, Gold, Slivered) by Jul. 1, 2006.
4. Master Program and Speaker Schedule by Jul. 1, 2006,
5. Marketing Strategy (Promotions, Ads, and Media) by Jun. 15, 2006.
6. Completed profificconcepts.com & www.wealth2006 website by Jun. 28, 2006.
7. On-site Event Management and Registration Staff identified by Jul. 15, 2006.
8. Workshop Handouts, slides completed by Jul. 15, 2006.
9. Program Agenda Itinerary completed by Jul. 1, 2006.
10. Event Venue, Flight Reservations, and Logistics arranged by Aug. 1, 2006.

Assumptions/Constraints:
1. Project will be completed on-time, under-budget, and according-to specifications.
2. There will be the proper funding, staffing, and resources available to effectively complete Project on-time, under-budget, and according to specifications.
3. Dates and locations will be reserved ahead of schedule.
4. Flight & travel arrangements completed for guests by Aug. 1, 2006.
5. The Event will not conflict with any other major event in the Bay Area this week.
6. The weather will not adversely impact this event.
7. The Marketing Campaign will lead to a high participation rate and a high ROI.
8. There will be adequate staff and volunteers to assist with event.
9. VIP Reception will be scheduled and sponsored by sponsoring agent.

Key Staff/Resources:
Kevin Lynch [Seminar Organizers]
Cindi Hart, Kim Auten, Dee Antioin, Aunya Shipman, Marion Hunt (Event Manager(s)]
Kevin Lynch [Project Manager and Sponsorship Director]
Personal Assistant for Vendors and Speaker, and Assistants [TBD]
Match Point Graphics [Graphic Designer for Posters]
Michelle Price [Web Developer]
EXPO/Vendor Coordinator—[TBD]
Prolific Concepts Volunteers [Host and Ticket Counter—TBD]
Fran Briggs [PR/Publicist]
Affiliates, Super Affiliates, Sales Force, e-mail Responders, [1 Shopping Cart]
Media Sponsors Coordinator [Local Radio Stations—TBD]
Marketing and Promotions [Prolific Concepts]
General Target Audience: Successful Entrepreneurs, Small and Mid-sized Business Owners, Executives, Real Estate Agents & Brokers, Banks, Funding Institutions, Corporate Leaders, Technology Professionals, and Business Investors.

| | | Severity/ | | Response or |
|---|---|---|---|---|
| Risk | Description | Impact | Probability | Contingency Plan |
| Financial | Inadequate funding and | High | Low | Focus on advanced |
| | Sponsorship for project | | | sponsorship |
| Financial | Marketing & Advertising | Med | Med | Focus on Joint |
| | expenses could exceed budget | | | Ventures, Affiliates, |
| | | | | PR, and Publicity |
| Schedule | Ensure no Holidays, Sports, | Med | Med | Review calendar of |
| | TV, Chamber, Partner conflicts | | | events (all) |
| Financial | Other major seminars, events | Med | Low | Research; |
| | or seimnars may conflict | | | magazines, |
| | | | | associations |
| Schedule & | Event is less than 3 months | Med | Low | Aggressive |
| Financial | away. Difficulty getting to S.F. | | | marketing; |
| Resources | Not enough staff available | High | Med | Recruit, delegate, & |
| | during event | | | volunteers |
| Resources | Not enough pre-registered | Med | Med | Intense Marketing |
| & Financial | attendees by deadline | | | & create incentives |
| Logistics | Event location will be canceled | Low | Med | Accept; signed |
| | or unavailable on day of events | | | contract mandatory! |
| Equipment | Not enough equipment | Med | Med | Need to purchase |
| | available on day of events | | | ahead of time |
| Logistics | No Single-Point of Contact or | Med | Med | Designate event |
| | Program Agenda on day of | | | planner ahead of |
| | events | | | time and pay fee |
| Financial | Not enough sponsorship, or | Med | Med | Tap into everyone's |
| | vendor donations | | | Network; Focus on |
| | | | | targeted Sponsors |
| Logistics | Hotels in the local area | Med | Med | Room Block from |
| | | | | Venue |
| Logistics | Speakers w/ same content; hog | Med | Med | Printed schedule & |
| | too much time on stage | | | time clock |

Success Criteria will be Measured in Terms Off:
1. At least 200 guests will participate in “Millionaire Marketing & Wealth” Seminar
2. Project will be completed on-time, under-budget, and according to specifications.
3. The event will lead to profits, referrals, positive exposure, teamwork, joint ventures, strategic alliances, and sponsorships throughout the Bay Area.
4. We will not have any safety issues, and we'll make a substantial profit.
5. There will be lots of spin-off sales opportunities as well.

Key Milestones:
Completed Budget by Jun. 1, 2006
Decorations, Banners, Signs, Chairs completed by Jul. 1, 2006
Venue Accommodations and Travel Arrangements done by Jun. 15, 2006
Confirmed Company Sponsors (Platinum. Gold, Silver, and Lead) by Jul. 1, 2006
Marketing Strategy (Promotions, Ads, and Media) by Jun. 15, 2006
www.prolificconcepts.com & www.wealth06.com Websites completed by Jun. 28, 2006
Event Brochures and Itinerary completed by Jul. 1, 2006
Identified list of Staff, Volunteers, and Resources by Jul. 15, 2006
50% pre-sale ticket sold by Jul. 15, 2006
Marketing Material complete and circulated by Jul. 1, 2006
All expenses paid ahead of time—profit dates begin by Aug. 1, 2006

### General Game Plan

A) Conduct Market Research: Identify Market first; locate hungry customers; deliver product/service. Start with your internal existing customers. Utilize referral Marketing Strategy. Focus on building and tracking your database. The database is the key to our business success. Utilize your internal database first before going after new clients.

B) Automate Marketing Systems: Focus on putting our marketing efforts on “Auto-Pilot.” Put together systems that will act or operate in a manner that is essentially independent of external influence or control.

C) Develop Strategy; This is the general message, game plan and road map. It has to do with what you say, how you say it, and who you say it to. The planning and strategy is the most important element of the project plan.

D) Initiate Tactics: Is the tactics used to initiate a project. It is the tools and execution of the strategic plan (e.g. flyers, radio, direct mail, referral marketing, etc.).

### Market Research

Below is the general strategy plan to utilize far general market research:
What type of market do the clients respond to most? Newspapers? Radio? Etc.
How do they buy, what do they buy, and how often?
What problems keep them up at night?
Who is the competition? Get added to their mailing list? Study their promotions.
Obtain the magazines, newsletters, newspapers, attend their conferences, tradeshows, and identify their associations.
What publications do their usually read? Do they prefer online advertising more than offline? Who are the decision makers? What are their major problems?
Talk to existing clients or clients who already purchased from you. Ask them what they like, want, and desire. Get testimonials and use them as leverage.
What do they like most about our event, product, seminar, etc.? Don't guess what clients want; ask our existing customer base.
Track all of your results, and document all of your survey questions and answers.
Attend the largest conferences; become a vendor or sponsor, and drive them to your website and/or a Toll Free—800 Number educating them on your product and services.

### Automate Your Customer Leads—Systems

Monopolize Your Marketing Place—Marketing System

http://www.mymessentials.com/freeresourceform

1Shopping Cart—Constant Contact w/ Customers, e-Zines, Auto-responders, etc

http://www.1shoppingcart.com/

Service For Life—Newsletters and Referral Marketing System

http://www.serviceforlife.com/index.aspx

Piranha Marketing System—Powerful Business Strategies in the World

http://www.joepolish.com/bcbox04/index.php

C-Vent—Automated Registration System

http://www.event.com

### Strategy

Below is the general strategy I believe we should use:
Concentrate on raising Sponsorship Revenue; EXPO Revenue; Program Ads
Secondly, concentrate on Author and Speaker's Back of the room sales
Identity the Target Audience, Ideal Prospects, and Demographics
Once you define your exact market, and then . . . place your products and services directly in his or her hands!!!
Utilize PR and Publicity versus Advertising
Focus on Driving Customers to a) Get a website with salesmanship copy; b) Get a Toll Free “800” number with voice broadcasting.
Focus on referrals, advocates, Affiliates, and Super Affiliates
Joint ventures, Contact Partners with large databases; create incentives for him or her to spread the message about sour company
Focus on being a Sponsor or Vendor at Seminars—take advantage of the marketing material that gets sent to the masses mentioning your company

### Tactics

Prolific Concepts, Inc will utilize its databases (46,000+) to spread the word. We will also utilize the internet, flyer distributions; e-mail blast, Press Releases, Event Calendars, Mixers and Networking Socials, National Conventions, newspapers, Trade Magazines, National Radio shows, fax blast (media contacts), Chamber of Commerce, Networking Meetings and Conferences, and local TV shows.

We will also use Direct Mail, Electronic Postcards, Drive Ad Campaigns. e-Marketing Campaigns, Newsletters, Viral Marketing, Surveys, Seminars, Gorilla Marketing Tactics, HR Events and Conferences, Tele-marketing, IBI Global Events, Voicemail Broadcast, recorded messages, Inner Circle Marketing Secrets, Monopolize Your Market Place Tactics, Internet Sales Copy, Joint Ventures, Media Brokers, Sellmorebooks.com Strategies, Marketing Maximization Program, National Publicity Summit, Newsgroups and Chat Rooms, Niche Marketing, Pay Per Click, PSA's, Voicemail Broadcasting, Yellow Pages, and Zairmail techniques.

### Timeline/Seminar Countdown

Item 1 (usually three months—ahead):
Choose speakers (if other than yourselves)
Start writing the Salesmanship Copy
Start writing designing workbooks and/or handouts
Choose program format (e.g. half-day, one day, two-day seminar, etc)
Decide program times (e.g. Sat., 9 am-6 pm, Sun, 9 am-5 pm)
Choose dream dates
Decide on city
Select hotel, conference center, site, or venue
Choose Food or beverages and order from hotel
Place orders for (signs, video equipment, mics, podium, & confirm letter to hotel)
Choose seating plan

Item 2 (usually too months ahead):
Finalize your ticket or enrollment price
Design sales material
Negotiate printing price for sales materials; order from printer
Pick up sales materials from printer
Put together magazine press kits and mail to (address)
Send sales materials to

Item 3 (usually one month ahead):
Finalize workbooks and other handouts
Place orders for: (audio duping, video duping, books from printer)
Order workbooks, evaluation forms, agendas and other handouts
Make travel arrangements for yourself, your assistants, etc
Make travel arrangements for speakers, presenters, and guest
Send press kits to newspapers

Item 4 (one week ahead):
Contact hotel/venue with attendance count and confirm arrangements

Item 5 (two days ahead):
Call hotel/venue with final head count and final confirmation or arrangements

Item 6 (the day before):
Familiarize self with room layout and facilities
Ensure site equipment is present and in working order
Check seating arrangement
Go over entire game plan with assistants and staff

Item 7 (day of event):
Check room setup again
Check equipment again
Set up tables for registration, signs, handouts, and products
Set up credit card terminal
Directions to hotel/venue operators

Following is a general overview of how we “initially” plan to market this event:

Overview

| | |
|---|---|
| Marketing Calendar | In place indicating specific marketing activities, |
| | events, etc., on a monthly basis. |
| Advertising | Advertise, as feasible, in local and trade |
| | publications (chambers, business, local |
| | newspapers, magazines, newsletters etc.) |
| Media Plan | Develop and implement: |
| PR & Visibility | Press Releases - Monthly/Quarterly |
| | Event Calendars - Monthly/Quarterly |
| | Attend Mixers and Socials, and distribute 10,000+ |
| | flyers throughout vertical markets |
| Community Outreach Presentations | Local business, chambers, rotary clubs, |
| | associations, groups, libraries, etc. Get the word |
| | out to their clients/members. Conduct and initial |
| | blitz in March, April, May, June 2006. |
| Web Sites, Radio, and TV | Postings and landing page at pppe web site |
| | Posted on partner's websites. Ads on KKIQ, |
| | KBLX, KMEL, More Public Radio, Comcast, and |
| | KBLCtv, CNBC-11, Street teams, and Public |
| | Broadcast Stations |
| Partner with Local Non-Profit | Identified Local 501c3 Non-Profits; and we will |
| Organizations (free press releases and | donate a portion of proceeds as a reward. Create |
| Public Announcements | early-bird specials |
| Promotion at Local Events | Events sponsored by identified organizations: |
| | Monthly and quarterly. Referrals from friends, |
| | colleagues, and partners |
| Attend Nat'1 Seminars and Conferences | Attend competitor's seminars and National |
| | Conferences; recruit Sponsors, Vendors & Clients |

Word-of-Mouth and Referral Strategy:

| | |
|---|---|
| Promotion by Referral Network | Reach out to existing network and barter |
| | techniques with other groups and organizations |
| Viral Marketing, Affiliates, and Super | Initiate a global viral marketing campaign; create |
| Affiliates | incentives for others to recruit guest, vendors, and |
| | sponsors for our event. |
| Clients, Workshop Attendees, Readers | Actively solicit referrals and reinforce word-of- |
| | mouth marketing through consultations. |
| | workshops, presentations, and readership. |

General Business and Seminar Topics may include:
“Critical Factors for achieving Business and Personal Wealth”
Master Direct Response Sales Copy Writing
Viral Marketing, Affiliates, Joint Ventures, and Super Affiliates
“How to Overcome Obstacles to Success”
“Internet Marketing and E-mail Marketing”
“How Experts Build Empires & Constant Income Streams”
“Cutting-Edge Strategies for Achieving Business Success”
“Getting the Winning Edge on the Competition”
“Direct Mail, Information Products, the Power of Networking”
“Instant Income for your Small Business”
“Publicity, Public Relations, and Referral Marketing”
“Niche Marketing and Loyalty Marketing”
“E-mail Marketing”
“Strategic Planning for your Business”
“Fundraising, Financial Management, Accounting, and Tax Strategies”
“Outsourcing, Project Management, and Effective Sales Strategies”

Written Authorization:

| | | |
|---|---|---|
| Title | Name | Signature and Date |

| | |
|---|---|
| Prolific Concepts, Inc | Kevin Lynch |
| Partner (Other) | |
| Partner (Other) | |
| Partner (Other) | |
| Partner (Other) | |

Comments: N/A

### Appendix—Target Audience

Target Audience For This Event: People who have found ways to make money, but don't know how to really build wealth and profits. People who are moderately successful either as entrepreneurs or in jobs/careers. Business owners who want to take his/her businesses to the next level. My general audience can live anywhere in the world where English is spoken.

Emotions I'm Trying To Tap Into: Fears, Guilt, Greed, and/or Exclusivity. I would like to target people who have attended before, but I'm trying to rapidly grow my database as well, so 60%-75% will be new audiences. I really want “successful business owners” who want to take his/her business to the next level!

Audience worries: My general audience worries about not having enough money to retire, wanting to retire young, protecting their assets from lawsuits. Lots of my audience are real estate investors, and don't know how to leverage their income. They worry about how to make smart biz moves or investments, both is domestic markets and international markets, and in real estate and other ventures.

My General Audience Has Been: Successful Entrepreneurs, Small and Mid-sized Business Owners, Executives, Real Estate Agents & Brokers, Banks, Funding Institutions, Corporate Leaders, Technology Professionals, and Business Investors. I usually get lots of Realtors, local Chamber members, and Learning Annex crowds.

Clients and homeowners: Median incomes of $88,000-$171,799, and median home values of $451,000-$1,245,200, clients who want to purchase new homes, refinance, obtain investment property, retirement property, and equity loans.

General Population: Very diverse crowd. White 45%, African American 20%, Latino 20%, and Asian 15%. Our typical consumers are professional women 45% (aged 24-44), and men 55% (aged 34-46). Our typical audiences are Baby Boomers (59%), and young-adults (41%) and rising.

Communities #1: Very affluent areas; San Ramon, Blackhawk, Danville, Dublin, Walnut Creek, Alamo, Pleasanton, Concord, Lafayette, Orinda, Moraga, San Leandro, Hayward, Oakland, San Francisco, Fairfield, Castro Valley, Livermore, Sunol, Tracy, Pleasant Hill, Emeryville, Fremont, Martinez, Fairfield, Stockton, Berkeley, Antioch, Sacramento, and Pittsburg.

Communities #2: Santa Clara, San Jose, Mt. View, Milpitas, Palo Alto, San Francisco, Campbell, Los Gatos, Cupertino, Sunnyvale, Saratoga, Gilroy, Los Altos, San Carlos, Redwood City, San Mateo, Foster City, Menlo Park, Half Moon Bay, Burlingame, Belmont, & Foster City.

Demographics:

| | |
|---|---|
| Gender | |
| Men | 55% |
| Women | 45% |
| Marital Status | |
| Married | 42% |
| Not Married | 58% |
| Household Income | |
| Average Household | $467,200 |
| Median Household Income | $88,000–$171,799 |
| Age | |
| Age 25–54 Years | 68% |
| Median Age | 38 Years |
| Entrepreneurial Interest | |
| Plan To Start Own Business | 31% |
| In Next 24 Months | 40% |
| Interested In Owning A Franchise | 40% |
| Education Level | |
| College Graduate | 72% |
| Graduate School Degree | 37% |
| Own Real Estate | |
| Own Primary Residence | 72% |
| Own Additional Property | 37% |
| Net Worth | |
| Average Net Worth | $324,500 |
| Median Net Worth | $169,800 |
| Occupation | |
| Professional/Manager | |
| Business Owner/Partner | 21% |
| FINANCIAL/INSURANCE | |
| Investments | |
| Household Owns Stock | 52% |
| Household Owns Bonds/Mutual Funds | 49% |
| Household Owns Securities | 77% |
| Average Value of Securities Owned | $137,000 |
| Household Uses One or More Financial | 64% |
| Services (Accountant, Broker, etc) | |
| Insurance | |
| Own Any Life Insurance | 91% |
| Own Property and Casual Insurance | 78% |
| Average Face Value of Life Insurance | $273,000 |
| (Not Group) Owned by Household | |
| Retirement plans | |
| Own One or More Retirement Savings | 76% |
| Plans (i.e., IRA, Keogh, 401k) | |
| Travel | |
| Average Domestic Round Trips Via | 7 |
| Commercial Airlines in Past Year | |
| Average Foreign Round Trips Via | 4 |
| Commercial Airlines in Past Year | |
| One or More Business Round Trips | 54% |
| Via Commercial Airlines in Past Year | |
| Five or More Business Round Trips | 19% |
| Via Commercial Airlines in Past Year | |
| One or More Vacation Round Trips | 81% |
| Via Commercial Airlines in Past Year | |
| Average Nights Stayed at Hotel or | 12% |
| Motel In Past Year | |
| Rented A Car at Least Once Past Year | 62% |
| Average Car Rentals in Past Year | 5 |
| Average Car Rentals in Past Year | |
| Online Hotel Reservations | |
| Online Transportation Reservations | 46% |
| Online Transportation Reservations | 48% |
| Information Technology Products | |
| Computer | 88% |
| Have Purchasing Authority at Work for | 47% |
| Computer/IT Products/Services | |
| Use the Internet for Business or Personal Use | 88% |
| Use Cellular or Digital Phone While Traveling | 82% |
| Wireless Communication | 66% |
| Use Laptop While Traveling | 41% |
| Handheld PDA | 23% |
| Automotive | |
| Own or Lease Two or More Vehicles | 62% |
| Own or Lease Three or More Vehicles | 26% |
| Plan to Buy or Lease a Vehicle in the Next | 34% |
| 12 Months | |
| Interests and Activities | |
| Participates in Sports/Activities | 88% |
| Professional Organization Memberships | 30% |
| Community Involvement | 51% |
| Business Conference/Seminars | 57% |
| Mentoring, Volunteering | 44% |
| Entertain One or More Times A | 37% |
| Month at Home | |
| Entertain One or More Times A | 41% |
| Month Outside the Home | |
| Reader Involvement | |
| Read 4 Business Magazines and Journals | 61% |
| Read Business Newspapers | 79% |
| Kept Issue with Business Articles for Reference | 60% |
| Spent 1 Hour or More Reading | 72% |
| Black Enterprise, Wall Street Journal or | |
| Business Week | |
| Average Time Spent Reading Business Magazines | 1.5 Hours |

### Seminar Planning Guide

“How to Profitably Produce World-Class Seminars on a Shoestring Budget”

Index of Checklists

Section 1
1. NEEDS ASSESSMENT—Seminar
2. BUDGET
3. THEME
4. AGENDA
5. PRODUCTION SCHEDULE
6. SITE RESEARCH & SITE INSPECTION
7. VENUE CONTRACTS
8. MARKETING

Section 2
9. PRESENTERS
10. PRE-EVENT REGISTRATION
11. LODGING
12. MEETING ROOM SET-UP—AUDIO/VISUAL
13. FOOD & BEVERAGE
14. ENTERTAINMENT
15. DÉCOR
16. TRANSPORTATION

Section 3
17. ACTIVITIES
18. GIFTS & AWARDS
19. PROGRAM, HANDOUTS, & SINAGE
20. THE FINAL STRETCH
21. ON-SITE REGISTRATION
22. ON-SITE MANAGEMENT & PRE-SEMINAR MEETING
23. EVALUATIONS
24. BILL VERIFICATION

Needs Assessment

This checklist is the first step in understanding the scope of your Seminar. This list will assess your basic needs and will help you to organize a successful event. Having this important information completed up front will save you time and money down the road.

General Seminar Information:
Name of the seminar
Name of the organization hosting the seminar
Type of business
Agenda of business
Agenda for the seminar
Goals and objectives for the seminar
Total Seminar budget
Seminar dates
Alternative dates (if available)
Seminar location (if pre-determined)
Location criteria
Specific times of the seminar
Dates and names of any holidays and/or city-wide events that may impact the Seminar
Total number of anticipated attendees

Seminar Project Manager:
Name
Title
Company
Address
Phone number
Cellular phone number
Pager number
Fax number
E-mail address
Web address
Best time to call
Name and contact information for seminar decision maker (if different from contact)
Name and contact information for on-site planner (if different from contact)
Areas of planning that will need to be outsourced
Name and contact information for company or contractor hired for outsourced planning
Contact information for other key players on the seminar planning team

Seminar Background:
If this is a regularly scheduled seminar, list prior dates and locations
Past planning notebook is available for review (yes or no)
Past evaluations are accessible (yes or no)
Past marketing materials are available for review (yes or no)
Gifts and awards distributed in the past
Things that have worked well with this seminar in the past
Ways to improve your past seminar

Seminar Attendee Profile:
Percentage of local vs. non-local attendees
Percentage of male vs. female attendees
Average age of the attendees
Number of attendees bringing their spouses to the seminar
Number of attendees bringing their children to the seminar
Seminar is required, elective or incentive for attendees
Percent of domestic vs. international attendees
List of any VIPs attending this seminar

Event Marketing:
Name of contact information for person or group managing the marketing for this Seminar
Target market
Marketing strategy
Marketing timeline (consider key deadlines like hotel cut-off date)
Invitations, brochure mailings or other printed materials being distributed
Cost breakdown for attending this seminar, including seminar registration fees
How website will be used

Seminar Sponsorship:
Name and contact information for person managing the sponsors for this seminar
Previous sponsors
Sponsorship goal
Potential new sponsors

Seminar Agenda/Content:
Name and contact information for person managing the development of agenda/content for this seminar
Total number of meeting days
Agenda for the seminar
Number of tracks that will be created
Maximum number of concurrent sessions

Seminar Logistics—Presenters:
Name and contact information for person managing the presenter logistics for this seminar
Name of person coordinating presentations, if not the individual presenters
Number of presenters needed
Determine whether in-house or outsourced presenters will be used

Seminar Logistics—Materials:
Name and contact information for person managing the materials for this event
Name and contact information of company producing materials
Materials needed
   Signage
   Banners
   Name badges
   Tent cards
   Welcome letters
   Agenda
   Programs
   Hand-outs
   Presenter bios
   List of attendees
   Evaluation forms
   Tickets for drawings
   Special event fliers or tickets
   Map of area/local attractions
   Meal vouchers

Seminar Logistics—Site Booking
Name and contact information for person managing the site bookings for this seminar
Type of venue(s) to be booked
Top three priorities in choosing the venue(s) for this seminar
Preferred venues(s)
Name of the person who will conduct the site inspection, if required
Important contract stipulations to be considered
Name of person signing the final contracts(s)
Method of payment for the venue costs

Seminar Logistics—Lodging:
Name and contact information for person managing the lodging for this seminar
Dates that lodging is required
Number of rooms needed per night
Rooms will be single or double occupancy
Number of VIP suites required
Overflow hotels will need to be booked (yes or no)
Range for the sleeping room rate
Reservations will be handled through rooming list or call-in

Seminar Logistics—Meeting Space:
Name and contact information for person managing the meeting space logistics for this seminar
Number of meeting rooms required each day
Dates and times required for meeting rooms
A 24-Hour hold is required on meeting rooms (yes or no)
Special audiovisual needs effecting the meeting space
If there is a General Session room, list space required
Set-up style for the General Session room
Number of people each breakout room must accommodate
Set-up style for the breakout rooms
List any additional space needed for the following:
   Registration
   Meals and receptions
   Exhibits
   Activities
   Office space
   Storage
   Presenter ready room
   Other

Seminar Logistics—Audiovisual/Production:
Name and contact information for person managing the audiovisual needs for this seminar
In-house or outsourced audiovisual/production will be used
List general audiovisual needs (such as rear screen projection and staging) for the following:
   General session
   Breakout rooms
   Meals
   Exhibits
   Registration
   Office space
   Receptions
   Presenter ready room
   Other

Seminar Logistics—Catering
Name and contact information for person managing the catering for this seminar
In-house or outsourced catering will be used
Name and contact information of person within catering department or company
Number of breakfasts to be served
Number of lunches to be served
Number of receptions being held
Number of dinners being held
Number of breaks being held
Times and locations of all meal functions
Programs will take place during meals (yes or no)
Times and locations of off-site meals, if applicable
Anticipated attendance at each meal function

Seminar Logistics—Transportation
Name and contact information for person managing the transportation
Determine types of transportation required
   Air
   Ground—airport
   Ground—intra-event
In-house or outsourced transportation services to be used
Name and contact information for representative within transportation department of company
Attendees will book their own transportation (yes or no)
A group airfare package will need to be negotiated (yes or no)
A group ear rental package will need to be negotiated (yes or no)
List all transportation costs to be covered by the attendees/speakers

Seminar Logistics—Special Events/Activities:
Name and contact information for person managing the special events/activities for this Seminar
Date, time and name of any special events taking place
List any off-site activities
There will be a special program created for spouses (yes or no)
There will be a special program created for children (yes or no)
There will be a need for a photographer (yes or no)
List any entertainment needs
List all special events/activities costs to be covered by the attendees

Gifts/Awards:
Name and contact information for person managing the gifts, giveaways and awards for this event
Name of company providing gifts, giveaways and awards
List any gifts and giveaways and who will receive them
List any awards and who will receive them

Registration—Pre-Event:
Name and contact information for person or company managing the registration for this seminar
Ways in which attendees can register for this event
Opening and closing dates for registration
List any early registration discounts available to attendees
Reminders of registration deadlines will be sent to attendees (yes or no)
Determine cancellation and refund policy
Confirmation of registration will be sent to attendees (yes or no)

Registration—On-Site:
Name and contact information for person or company managing the on-site registration for this seminar
Dates and times of on-site registration
Determine on-site registration
Determine on-site space needs
There will be computers on-site to assist with registration (yes or no)
Phone and data lines needed

Budget

Seminar Marketing and Advertising:
Public relations and marketing
Advertising
Graphic Design
Copywriting
Paper
Pre-registration forms/brochures
Special stationary
Envelops
Printing
Mailing lists
Fulfillment
Package

Site Visit:
Air
Ground
Meals
Lodging

Pre-Seminar Registration:
Online usage fees
Registration processing service fees
Telephone expenses
Credit card merchant fees
Support staff

Venue:
General session space
Exhibit space
Breakout rooms
Hospitality suites
Press room
Storage
Office
Speaker ready room
Set-up fees
Room deliveries
Non-refundable cleaning/security deposits

Audiovisual and Telecommunications:
Sound
Microphones
Lighting
Video projection
Video taping
Audio taping
Electricity
Power strips
Patch fees
Audience response system
Data lines
Handsets
Phones
Radios
Pagers
Cellular Phones
Screens
TV/VCR
Fax machines
Computers
Printers
Copy machines
Flipcharts
Tents
Dance floor
Networking costs
Technician costs
Production services
Staging
Labor
Taxes

Seminar Materials—On-site Registration and Office Needs:
Registration forms
Welcome package envelops/bags/baskets
Badge holders and badges
Pens and pencils
Tent cards
Welcome letters
Agenda
Programs
Handouts
Speaker Bios
List of attendees/roster
Workbooks
Evaluation forms
Special invitations
Award Program
Tickets for drawings
Special event flyers or tickets
Map of area/local attractions
Meal vouchers
Lanyards
Ribbons
Furniture
Counters
Supplies
Radios

Personnel/Staffing:
Planner consultants
Travel coordinator
Registration staff
Welcoming or “meet and greet” staff
Clerical
Security
Childcare
Accounting
Legal
Interpreters/translators

Speakers:
Keynote
Training leaders
Facilitators
Master of Ceremonies
Teambuilding
Speaker lodging, travel and other expenses

Lodging:
Sleeping rooms
Suites
Tax
Incidentals
Telephone
Room service
Mini bars
Health club
Staff gratuities
Porter fees
Late checkout
Resort fees
Non-refundable cleaning/security deposits

Transportation:
Air
Airline tickets
Airport transfers
Special airport facilities
Offshore departure tax
Visas
Documentation
Ground
Rental cars
Gas
Parking
Valet
Mileage reimbursement
Intra event ground transportation
Mobile phones
Tips
Sky caps
Porter fees
Bell person

Catering:
Breakfast
Lunch
Dinner
Receptions
Breaks
Oil-site or en-route meals and drinks
Liquor
Liquor license
Bartender/server fees
Corkage fees
Ice sculptures
Service charges
Staff gratuities
Taxes

Special Events/activities:
Activity costs
Sight seeing outings
Spouse's program
Children's program
Entertainer
Band
Disc jockey

Décor:
Banners
Sinage
Flowers/plants
Centerpieces
Linens
Place cards
Stage or set design
Drapery
Props
Theme party décor and rentals
Dance floor
Tents

Gifts/Giveaways/Awards:
Awards/plaques
Gifts for;
Welcome packets
VIP
Speakers
Volunteers
Attendee's spouses
Attendee's children
Pillow gifts
Prizes for sporting events
Prizes for contests
Apparel

Shipping:
Packaging supplies
Packing fees
Shipping
Handling
Postage
Storage
Freight

Other:
Business center
Transcribing
Interpretation and translation services
Currency exchange
Insurance
Wheelchairs
Coat and package cheek
Photographer

Estimating Revenues:
Registration fees
Sponsor funds
Special event ticket sales
Guest or spouse ticket sales
On-site merchandise sales
Commissions from venues or other vendors
Program advertising revenue sold
Grants
Advertising sale

Example:

200 Members @$500=$100,000

100 Non-members @$750=#75,000

Sponsor funds@$10,000

Total Revenue=$385,000

Administering the Budget:
Break down expenses and revenues by month
Assign someone to track and report on the budget monthly. Have all expenses and revenues run through this person,
Research variances in budget each month to ensure you are staying on track
Revise the budget if needed to relied increases or decreases in attendance or any other significant factor.

Theme
What are the dates of the seminars
What time of the year is the seminar being held?
Are there any holidays or other special dates to consider near the time of seminar?
Where will the seminar be held?
Does the location present theme options?
What is the purpose of the seminar?
How would you define the attendees?
What do you want the attendees to take away from the seminar?
What is the organization's direction or goals?
What is the “temperature” of the industry?
What are hot topics within the industry?
What have been previous themes for this seminar or for this group?
What are some key words or phrases that describe the group?

Strategies for a Successful Theme Brainstorming Session:
Find a quiet space away from work
Include all key people in the brainstorming session
Clearly define the objective and desired outcome of the brainstorming session before you begin
Prepare your tools;
Event planning materials, history and budget
Dictionary
Thesaurus
Flipchart
Markers
Adhesive tape

Answer all of the questions above at the beginning of the session
Have the mindset of “no idea is a bad idea”
Designate one person as the idea recorder. Consider writing each idea on a sticky note that can be attached to the flipchart and easily rearranged.
Record all ideas and wait until later to evaluate them. Aim for quantity, not quality
Cluster all similar ideas by continuing to rearrange sticky notes
Narrow down the best options by having each person vote on their top three ideas for the theme
Either present the best three ideas (with reasoning) to your decision maker, or if the group has final say, narrow the list down to the best theme based on consensus
File all of the ideas from the brainstorming session away for future theme development meetings
Ways to Weave the Theme Throughout the Seminar;
Create a Seminar logo to match the theme
Ask the presenters to link; their content and conclusions to the theme

Incorporate the Theme in:
Sinage
Materials
Table tents
Name badges
Décor
Stage set
Centerpieces
Meals
Music
Contests
Awards
Giveaways
Clothing

Agenda

Review Initial Considerations and Begin Creating the Agenda:

What is the Length of the Seminar

Review last year's agenda:
What worked and why?
What did NOT work and why?

General Session:
When will General Session(s) be held?
How long will General Sessions(s) last?

Keynotes(s):
Will there be keynote presentations?
How many?
How long will each last?
What are the best day(s) and time(s)?

Breakouts:
How many tracks will be ran?
How many breakouts in each track?
Will breakout sessions be repeated? If so, how many times?
How long will each breakout run?
What topics/presenters should you repeat from previous seminars?
How many presenters are needed?

Exhibits:
Will there be an expo or trade show?
If so, when would be the best times to open the floor to attendees

Meal Functions:
When are the meal functions?
How long will they last?

Special Events/Activities:
Will there be special events, receptions, awards, activities, tours, off-sites, etc?
What are they?
How long will they last?
What are the best day(s) and time(s)?

Other:
Time of registration

Creating Your Printed Piece:

Tentative agenda should include:
Tide of Seminars
Dates(s) and location of Seminars
Mission and objectives
As much information as possible on topics, content and speakers to draw audience
Highlights of key events
Outline of tentative schedule with blocked out general sessions, breakouts, meal functions and activities

Find program agenda should include:
Title of Seminars
Date(s)and location of Seminars
Mission and objectives
Detailed schedule of sessions, activities, meals, breaks and other events
Title
Session, activity or event description
Date and time
Length of session, activity or event
Locations
Speaker information and bios

Production Schedule

12 Months Out:
Set objectives and complete Needs Assessment
Determine best date options
Check with local Convention and Visitors Bureaus for Date Conflicts
Conferon—RFP (bidding war)
Brainstorm locale, theme and format
Develop preliminary budget
Create Seminar specifications for venues
Research and suggest venue options
Conduct site inspections to top three venue choices
Venue chosen and contract requested
Contract negotiated
Contract and pricing finalized
Produce production schedule and assign champions
Develop logo based on Seminar theme
Create tentative agenda
Invite keynote presenters
Establish sponsorship levels and begin solicitation
Create marketing strategies and timeline

9-11 Months Out:
Negotiate airline contract
Negotiate car rental contract
“Save the Date” email blast or postcard to prospective attendees
Contract overflow sleeping rooms
Create list of alternate hotels
Submit tentative agenda to venue
Determine list purchase
Send Call for Papers to presenters

6-8 Months Out:
Outline all presenter A/V needs
Determine material needs and assign champions
Reserve staff hotel block
Produce Request for Proposal for production/audiovisual company
Identify gifts and awards
Select ground operator
Set-up direct bill with venue

3-5 Months Out:
Update Website with Seminar information and registration link
Mail registration piece
Outline food and beverage needs
Determine security needs and secure vendor
Communicate venue shipping information to all parties
Fine tune agenda
Work with production company on stage set and production needs
Outline audiovisual equipment needs
Determine on-site staffing needs
Order office and communication equipment needed on-site
Begin creation of the seminar program
Outline on-site registration needs
Order gifts and awards
Determine entertainment needs
Contract entertainment

2 Months Out:
Finalize food and beverage menus
Order signage/banners
Order audiovisual equipment
Send presenter confirmations and itineraries
Determine on-site staffing needs
Finalize and print seminar program
Print handouts and materials
Assign sessions/presenters to rooms
Book staff air travel

One-Month Out:

Work with production company on program script
Receive, review and approve Banquet Event Orders from venue
Prepare attendee evaluation forms
Order registration computers, data lines, counters and phone

One-Week Out:
Final food and beverage guarantees to on-site and off-site venues
Produce name badges for staff, attendees and exhibitors
Pack and ship materials to venue;
Pack and ship materials to venue;
Attendee lists
Evaluation forms
Registration manuals

Attendee Programs/Handouts
Supplies
Badges
Registration equipment and supplies

Confirm Vendor Arrangements
Entertainment
Transportation
Activities
Décor
Registration staff
Other

Provide Hotel with Seminar Summary or Resume:

Confirm Arrival of All Materials

On-Going Duties:
Sponsor solicitation
Manage room block/attrition
Receive and process registrations
Send attendee confirmations
Registration/attendee reporting
Review of production schedule
Track all expenses
Compile data to assist with, budget to actual analysis
Conduct regular meetings with champions

On-Site Management (See On-Site Management Checklist):

Post Event:
Debrief with staff and vendors
Review bills for accuracy
Produce final attendance reports
Process and report evaluation results
Create final budget to actual report

Site Research & Site Inspection

Site Research:

Determine the Following in Advance:
Date or time frame
City and area
Level of facility
Budget
Space requirements such as number of sleeping rooms needed

Get recommendations from local Convention & Visitor's Bureaus

Find out if there are any “citywide” events over your dates

TV Shows, Concents, Sporting events?

Create an RFP (Request for Proposal) to Include:
Preferred dates
Arrival/departure days and pattern
Number of attendees
Number of room nights
Approximate lodging budget
Purpose or overview of Seminars
Meeting space needs
General audio/visual overview
Contact information
Deliverables (e.g. proposal, sales packets, menus, video, etc.)
Deadline for return
Other requirements

Determine Who Will Receive an RFP:
Convention & Visitor's Bureau recommendation
Internet research
Call to determine who initial sales contact will be
Fax or e-mail RFP
Review proposals and floor plans to ensure space is appropriate
Identify top choices
Create availability spreadsheet using key determining factors (e.g. dates, price, size, etc.)
Schedule site visit and inspection

Site Inspection Form

General Venue Information:

Venue information:

Name:

Address:

Contact:

Phone:

Fax:

e-mail:

Web address:

When was the property built?
When was the most recent renovation completed?
Are there any scheduled renovations during the seminar dates?
What other programs might be occurring at the venue in the same time frame?
How many phones are located within the meeting space?
How many restrooms are located within the meeting space?
Are there a sufficient number of elevators in the venue?
What are the dimensions of the freight elevators?
Is there sufficient parking?
Is the parking free or is there a charge? Cost for Sell-park? Cost for Valet?
Is the Valet run by the venue, or is it a separate entity?
Are there shops or attractions nearby and easily accessible?
Does the general layout of the venue offer convenient access to all pertinent areas?
Does the venue have a storage location for supplies and materials?
Does the venue have a loading dock? Does it require a lift gate?
What amenities does the venue offer (e.g. health club, pool, business center, spa, gill shops )$
What are the costs to guests for these amenities?
Will the venue have a Business Center? What are the hours?
Does the venue have a Business Center? What are the hours?
Where is the closest quick-copy center and office supply store? What are the hours?
How close is the nearest medical facility?

Transportation:
Does the venue have complementary shuttle service? If so, can they support the entire group?
What is the procedure for using the hotel shuttle?
If shuttle service is not complimentary, what is the costs?
What is the distance and travel time to and from the airport?
What type of transportation is available in and around the city, and to local attractions?
Can the hotel suggest a local ground transportation company?

Meeting Spaces:
When will the room(s) be available for set up?
Does the capacity of the room match the needs of the program, including staging requirements?
Can pre-function accommodate continental breakfast, reception and breaks?
Can a speaker preparation area be provided?
Is the shape of the room and ceiling height conducive to set-up needs?
Are there any obstructions in the room that will prevent viewing of screens or monitors?
Is lighting bright and evenly spread throughout the room?
Does room have windows? Can they be covered for multi-media presentations?
Are meeting room chairs comfortable?
What size are the classroom-style tables? What size are the banquet tables?
What are the restrictions on décor in the room (e.g., tape on walls, confetti, balloons)?
Is there lighting and air-conditioning controls in the room?
Are the rooms sound proof?
Does the room have a built in stage? If so, what is the height and size?
Are all meeting rooms and break out rooms on one floor for easy access?
Where is the closest house phone so that venue staff can be reached quickly in the event of a problem?
Is the room available for 24-hour hold?
Can rooms be locked? If not, does venue provide security?
If rooms have locks, will you be able to have several sets of keys?
Can rooms be re-keyed? What is the costs?

Audiovisual Assessment:
Is there an in-house A/V department? Is the group required to use them for some or all A/V needs?
Is there an A/V specialist on hand who is able to handle equipment problems?
Obtain price sheet. Does the price include rehearsals, insurance, security, labor rates and union considerations?
What is the cancellation policy?
Who is responsible for lost, stolen or damaged equipment?
Is the equipment insured?
Can last minute equipment demands be met? What are the additional costs?
Is there a built-in sound system in the rooms?
How many computer hook ups are there (phone jacks and power outlets)?
Is electrical power sufficient for equipment needs?
What are the fees associated with bringing in outside equipment or personal?
Are there hang-points for lighting banners and signage?
What is the cost for power?
What are the rigging costs?
What type of high-speed Internet connection do they have and what is the cost?

Food and Beverage Assessment:
Is there an on-site restaurant(s) How many? Types?
Does the venue have in-house catering facilities?
Obtain complete menu packets with pricing?
Has the banquet department handled similar programs (e.g. size, special needs, type of service)?
Can the facility provide recent references from groups with similar program needs?
Does the venue have a good reputation for food and beverage quality?
Does the restaurant and banquet staff share the same kitchen?

Sleeping Room Assessment:

What type of sleeping rooms does the venue offer?

Do the rooms appear to be clean and well appointed?

What amenities are offered to guests in their rooms?

Is room service available? What are the hours?

What is the percentage of smoking vs. non-smoking rooms?

When were the rooms last renovated?

What is the distance between the sleeping rooms and meeting rooms?

What are the charges associated with local and long distance phone calls?

Do the rooms have windows that open?

Is each sleeping room equipped with it's own temperature control?

What is the percentage of rooms with a view?

Staff Assessment:
How responsive is the staff to your request?
Is there a general feeling of warmth and courtesy from the staff?
Front Desk
Concierge
Bellman
Restaurant
Gift Shop
Room Service
Housekeeping
Valet Attendant(s)

Activities:

What activities are available on property?

What are the costs for these activities?

Does the venue provide childcare?

Are outdoor or other areas available for activities or special events?

Does the venue provide support with activities (e.g., golf tournaments, etc.)?

What is the cost?

Venue Contract Issues:

General Contract Issues:

Complete names of all parties, addresses, and contact information as well as the name of the Seminar

Be Sure the contracting party is not listed as the name of the organization; unless they are one and the same

Actual Dates of the Seminar

Statement of whether the contract is a first or second option. A first option should specify the date by which the contract must be signed and returned to the venue. A second option should include the above, as well as the date by which the venue must notify you of its decision

Ensure that when you receive a first option agreement, it is a contract, not just a proposal

Steeping Room Block

Arrival and departure dates

If “shoulder nights” (days immediately before and after the Seminar) are needed, ensure they are listed in the contract with the same rate

Specify breakdown by type(s) of rooms/suites and number(s) per night

Beware of attrition clauses that lack you into payment for the entire contracted block

Be aware of release dates and penalties

Sleeping Room Rates

Specify rates by room type (e.g., single, double, deluxe, suite, non-smoking, smoking, etc.), and the percentage for each category

Applicable taxes (sales, occupancy) are outlined

Applicable charges for extra person in room are outlined

If the contract was initiated in another country, rates are usually quoted in that country's currency

Ensure commission percentage, and who it is paid to, is identified

Complementary Sleeping Rooms:

Negotiate complimentary rooms based on room block. Standard is one complimentary room per 50 revenue-producing rooms actually utilized

Determine how the camps are calculated, and whether they can be credited to the master account

Determine whether they are based on accumulative rooms or not

Determine if additional comp rooms will be extended to convention staff and/or guest speakers, or if a special “staff rate” will be given

Determine how many VIP upgrades will be given to the group

Outline Complimentary Site Visit rooms—number of rooms, and how many nights

Reservations:

Specify method of reservation (e.g., individual call in, rooming list, both, or third party)

Identify call in telephone number, as well as group discount code to be used

Identify call in telephone number, as well as group discount code to be used

Identify cutoff date—usually 4-6 weeks prior to the major arrival day. Indicate whether reservations received after the cut-off date will be honored at the group rate, or a rate at the venue's discretion

Specify when/if confirmations will be sent out by the venue

Specify and negotiate check-in/check-out times

Dishonored reservations: determine what compensation the venue will make for Seminar guests that are “walked” (e.g., free sleeping rooms at a comparable venue, free transportation to and from substitute venue, etc.)

Outline reservation cancellation policy

Billing Arrangements:

Determine what charges the individual will pay, and what the organization will be responsible for

Specify advance deposits required by the venue, and the due date(s). For individuals, a credit card guarantee or one night's deposit is usually required

Determine procedures required by the venue to set up direct billing

Specify authorized signatures and payment terms

Function Space and Meeting Arrangements:

List detailed space requirements including exact days, times, setups, and functions

List specific room names or a minimum square footage required

Determine exact date when the venue will provide definite room assignments

Determine if the venue reserves the right to move the group to other space. Can this be negotiated, and will the venue pay for financial repercussions of changing space (e.g. sinage, reprinting of materials, etc.).

Outline terms for releasing space, if need be

Determine venue's criteria for waiving meeting room rental fees

Set firm price for space rental, if applicable

Determine if there is a fee for “extensive” meeting room setups, and how its' defined

Identify charges for room turns or last minute changes to set-ups

Termination for Cause:

Under what terms can the agreement be terminated, in the event of an emergency over which no party has control (also know as an “impossibility”)? Terms should be mutual, and state that termination will be without a cancellation charge

Termination should be allowed for construction, change in management or ownership, bankruptcy, or the conflicting booking of competitor

“Without liability” is often missing from these clauses

Cancellation:

By the group—there should be a sliding scale of charges, as well as mitigation

By the venue—the group sold be compensated for all of its' losses

Watch for cancellation clauses that seek to recoup all revenue that the venue would have lost (e.g., restaurant revenue, gift shop revenue); damages owed should be in terms of lost room revenue and potential flood and beverage only

Ensure cancellation charges are calculated after allowed attrition and reductions

Americans with Disabilities Act:

Venue should warranties compliance

Specify the group's obligation

State mutual cooperation in identifying needs

Each party should indemnify the other for violations by the indemnifying party

Beware of vague language and one-sided obligation for the group.

Dispute Resolution:

Determine what method will be used—arbitration, litigation or mediation. If arbitration is chosen, parties should reserve the right to use courts for equitable remedies. Specify the site where the proceedings will take place

Determine who pays attorney fees

In the event the venue sues the group for collection of funds the group owes, the venue may want to be reimbursed for it's attorney fees

Any dispute resolution should be at a neutral site

Miscellaneous Issues:

Indemnification should be reciprocal and each party should be responsible for its' own negligence

The venue and group both agree to carry adequate liability that protects both parties against claims arising from activities in the venue during the event

The venue should warrant the condition of the facility. It should be the same or better than at the time of the on-site visit or contract signing

The venue should warrant the condition of the facility. It should be the same or better than at the time of the on-site or contract signing

The venue should state its adherence to laws regarding fire, safety and health codes

Specify by which state law the contract will be governed and constructed

Make sure titles are used when authorized parties sign the contract on behalf of their organization

Determine whether a faxed document is valid, as long as the original is received within 72 hours or receipt of the fax

Outline the use of outside contractors, and whether a fee will be assessed

Marketing—Outline Marketing Strategy:

Review last year's strategy and determine what worked and what did not work

Outline marketing goals and objectives

Determine audience including attendees and sponsors

Outline Types of Promotions to be Used:
E-mail blast
Fax blast
Radio and/or TV Ads
Articles
Promotion at other events
Newsletters
Direct Mail pieces
Website
Inserts into renewal letters or other mailings
Press Releases

Determine number of promotions

Outline cost of promotions

Create a marketing budget

Create a marketing timeline or schedule

Implement Marketing Strategy:

Graphics & Printing:

Research and select graphic designer

Solicit bids from printers

Select printer and share marketing print schedule

Create logo based on theme

Determine how logo/theme will be woven throughout materials:
Event promotions
Website
Invitations
Final agenda/proceedings
Badge inserts
Tickets
Giveaways
On-site registration materials
Signage

Mailing List & Fulfillment:

Research outside mailing list options for purchase or trade

Request list from major sponsors to use

Update mailing list

Create codes for testing various lists

Obtain mail lists/labels

Merge/purge mailing list to eliminate duplicates

Research current Post Office regulations

Determine whether your will stamp or meter mailings

Hire fulfillment house for preparing and sending mailings

Brochures & Mail Pieces:

Sponsor mail piece:

Create sponsorship marketing piece

Proof and print sponsor materials

Mail sponsor materials

Initial Attendee Mailing (Email or Fax Blast):

Include Critical Information:

Name of Seminar

Date of Seminar

Location of Seminar

Check website for more details

Announce keynote (if applicable)

Spotlight new features

Proof and print initial mailing (e-mail or lax blast)

Major attendee mailer/brochure:

Include Critical Information:

Repeat info from initial mailing (email or fax blast)

Pricing structure

Registration information and form

Tentative agenda

Tracks and sessions

Benefits of attending

Presenters (if applicable)

Meals

Optional tours and add-on activities

Logistics:

Lodging Information

Venue name

Address

Phone

Price

Reservation Deadline

Group Code

Airline Reservations

Airline or travel agency name

Phone or number

Discount codes

How to book

Car Rental Information

Company

Phone number

Discount codes

How to book

Other Ground Transportations

Proof brochure

Print brochure

Send brochure to fulfillment house

Mail brochure

Website

Create website with general information

Create online registration form or link to Internet-Based Registration System

Update website with tentative agenda and logistical information

Ensure most current information is continually added to website

Public Relations:

Create press releases

Create advertisements

Target both local and national media in trade magazines, newsletters, newspapers, magazines, radio, and television

Send press releases

Proof ads prior to print

Place ads

Identify what media will be invited to attend the seminar

Create media kit

Register media attendees and pre-print badges

Identify press room

Staff press room

Set up press Seminar

Send thank you notes to press

Other:

Identify need for additional marketing push or promotion

Send lists of pre-registered attendees to sponsors

Send Seminar reminders and last chance broadcast fax/e-mails

Prepare Seminar proceedings for giveaway or sale at Seminar

Create sinage and banners for Seminar

Obtain or create sponsor banners

Ship programs, handouts and sinage

Controlling Your Marketing Costs [Add Those Tips from HSMAI Women]:

Obtain written bids from at least three vendors

Hold vendors to bids

Work in advance to avoid rush charges

Use standard paper sizes and stock

Use standard PMS ink colors

Avoid unnecessary effects that may increase the cost of printing (e.g. embossing, die cuts, perforations)

Minimize changes

Use bulk mail postage

Thorough proofing of mailers by several individuals

Consider trades for ads or printing

Get Sponsors to promote Seminar

Use press releases whenever possible

Use “clean” mailing list

Presenters

Identify Theme and Topic:

Review your selected seminar theme

Identify corresponding topics which compliment theme

Determine budget and honorarium structure for presents

Identify presenters who you would like to invite back from previous Seminars

Identify presenters who are well-known and/or have knowledge of selected topics

Presenter Selection:

Prepare List of Potential Presenters

Prepare Call for Papers or invitation outlining;

Name, dates, location and times of Seminar

Goals of Seminar

Size and composition of audience

Theme

Sponsors and partners

Suggested topic(s)

Time allotment

Proposed fee and expense agreement

How to respond and to whom

When to respond

When to respond by

Ask Presenters to Return the Following:

Availability and special requirements or limitations

Outline of presentation

Audiovisual requirements

Biography

Fee and expense requirements

Verification of spelling of name, title, and organization

Receive and review proposals

Narrow field to top choices

Interview final candidates

Select final presenters

Send contract or confirmation letter to presenters outlining your agreement:
Logistical information including hotel, transportation, meals, special events, etc.
Topic and/or title of session
Time of session
Presenter arrival and departure time
Deadline for receiving material/handouts
Permission to tape or record session
Agreement to sell own products/services (i.e., presenter-authorized books and tapes)
Other policies and agreements
Finalize fee and expense agreement

Pre-Event Logistics:

Obtain final biography from presenters for printed materials

Request presenter photograph for printed materials

Receive and review materials and make changes if necessary

Have materials reproduced for distribution at Seminar

Have presenter complete a meeting Room Needs Form to include:
Audiovisual requirements
Room set-up needs
Final arrival and departure dates

Make lodging reservations

Make air transportation arrangements

Determine special needs and security arrangements

Create name badge for registration pick-up

Arrange for delivery of welcome basket or amenity for sleeping room

Two weeks prior to event, create and send presenter itinerary with final event details to includes:
Date and time of Seminar
Location of Seminar including address and directions
Expected attendance
Lodging information with directions, phone and confirmation number
Final transportation arrangements with detailed times and confirmations
On-site contacts (hotel and planner) with telephone numbers
Location of presenter ready room
Presentation title
Date and time of presentation
Location (room) or presentation
Confirmation of room set-up and audiovisual needs
Dress/Attire
Planned rehearsal time
Any other important information or updates

On-Site Logistics:

Provide meet and greet for VIP presenter at airport

Welcome presenter and provide them with seminar packet materials, name badge, etc.

Remind them of planned rehearsal time

Make presenter aware of presenter ready room

Meet presenter in meeting room for rehearsal and sound check

Make any last minute changes to audiovisual and/or room set-up

Coordinate time and place for introduction to MC, introducer, room monitor, technical staff, etc.

Review the start and end time with presenter

Handle any special requests

During the Session:
Pass out and collect evaluation forms
Track number of attendees (and if possible, who attended)

After the Session:

If departure times are tight, ensure presenter makes airport transfer

Follow-Up:
Provide presenter with final evaluation results
Send letter of thanks
Reconcile and pay presenter bill

Presenter Meeting Room Needs Form

Please complete this form and fax back to:

Or e-mail to:

Presenter Information:

Name

Phone

e-mail

Date/Time of Arrival

Lodging Location

Date/Time of Departure

Presentation Information:

Date

Time

Location

Length of Presentation

Title of Presentation

Meeting Space Set-Up:

Please check one:

Classroom

Rounds

Crescent

Theatre

Hollow Square

Seminar

U-Shaped

Other (please describe):

Staging Requirements:

Please identify your staging requirements below (i.e., podium, tables, stool, water, etc.)

Audiovisual Needs:

Please clearly define your audiovisual/production requirements for your presentation:

Please address any questions or comments to ______@______

Pre-Event Registration

Registration Set-Up:

Determine who will champion the registration process

Determine registration policies and guidelines:
Cancellation policy
Refund policy
Group discounts
Payment policy
Early bird vs. regular fees
Early bird deadline

Determine who will take registration:
In-house
Outsourced

Select Registration Vendor (if Outsourcing)

Determine what information you want to collect on your registration form:

Name, title, company, address, phone, fax, e-mail

Package type, course selections

Seminar events, meals, tours, etc

Demographic information

Payment information

Set-up toll-free number to accept phone registrations, determine fax-in number, and mail-in address

Create Registration Forms:

Manual/faxable form

Seminar brochure form

Create Online Registration Form:

Test online form

Link online registration form to website

Registration Processing:

Create registration procedures and train customer service team on all aspects of the Seminar so they can knowledgeable respond to all customer queries and efficiently process registrations

Receive all advance registrations via:

Phone

Fax

Online

Mail

Enter data for all advance registrations:

Phone

Fax

Online

Mail

Prepare and send registration confirmations (fax, phone, online, mail)

Receive and apply cheek payments to registrations

Handle proper documentation of cancellations, including credit card refunds and request for check refunds

Call any attendee who has an invalid credit card—obtain a new card number and input

Handle brochure fulfillment upon request

Send reminder e-mails/faxes 10 days prior to event

Prepare for On-Site Registration:

Create budget that outlines costs for On-Site Registration: computer/printer(s), staffing, shipment, materials, etc.

Diagram on-site registration area including set-up of computer/printer(s) for badge corrections, exhibitor cheek in, attendee check in, attendee walk-in processing, and staff/speaker/VIP/press registration

Identify on-site registration sinage needs

Coordinate pre-event arrangements for accepting payments on-site (i.e., obtaining cash bags, cash, receipts, credit card handling, etc.)

Materials Production & Coordination:
Determine badge specifications
Order badge stock and holders, as well as ribbons
Obtain staff, VIP and speaker names for badge creation
Download attendee names, titles and organization from registration database. Make visual corrections to your database to ensure badges print accurately (i.e., change all caps and all lower ease registrations to correct case)
Print and stuff all badges
Create manual Check-in Reports that correspond with attendee, staff, VIP and speaker badges
Pack and ship badges and ribbons
Print and ship Check-in Reports (make copies for each on-site check in area)
Pack and ship holders for name badges
Pack and ship registration supplies (see below)
Print and pack on-site registration manuals
Verify arrival of all materials

On-Site Equipment Arrangements:

Registration Equipment
Determine number and type of computers, printers, and software
Create RFP for local/national computer rental company
Obtain bids from three top companies Negotiate contract and make final vendor selection
Order computer equipment, internal hubs, and tech support through selected vendor
Create equipment/registration area diagram outlining power and internet needs
Determine type of internet connection available at venue (if needed)
Obtain IP address from venue if using internet access on-site
Order internet connection and telephone (and lines) through the venue
Make final arrangements for computer installation, network set-up, and software downloads.
Notify computer rental vendor and venue
Verify needs one week prior and make changes to equipment orders if needed

Office Equipment:
Determine, equipment needed for your-staff office (i.e., computers, printers, copy machine, fax machine, software, telephone, etc.)
Determine what equipment you will bring and what needs to be ordered
Some equipment may be ordered through the venue (i.e., fax machine, phone, copier, etc)
Your computer equipment needs can be ordered at the same time you order your registration computers
Finalize all orders
Verify orders one week prior

On-Site Staffing Arrangements:

Determine hours of on-site registration

Determine peak hours of registration

Create staffing matrix outlining the number of registration staff needed during on-site registration hours

Determine whether on-site registration will be staffed by in-house employees or by hired temporary staff
If using outside staff, identify potential providers in the area
Send Request for Proposal to local/national staffing company(s)
Select vendor and send matrix outlining staffing needs
Create Staff Training Manual
Obtain names of staff
Send manual to all staff
Send manual to all staff
Double check registration numbers and adjust staff needs one week prior to event
Verify staff with vendor 48 hours prior to event

Registration & Office Supplies:
Registration materials (badge, reports, badge holders, etc.)
Cash register or cashbox
Credit card machine and slips
Blank name badges and holders
Calculators
Change/cash (in proposition to event size and admission fees)
Tickets, hand stamp or admission tokens
Confidentiality statements
Press kits
Pens and pencils
Highlighters
Plain computer paper and legal pads
Black makers—thin and thick
Clear packing tape
Push pins
White out
9×12 envelops
Lost and found box
Ruler
Rubber hands
Stapler
Tape and dispenser
Spool of fishing wire
Velcro (2 sided)
Duct tape
3-oulet extension cord
Scissors and box cutters
Paper clips
Set of dry erase makers
Sticky notes
Return mailings forms (FedEx forms)
Flashlight
Tools (screwdriver, small hammer, etc)
First Aid kit (including pain reliever)
Items to be sold

Lodging

Booking:

Review group history

Post venues

Room pick-up

Patterns

If history is not available, consider:

Number of attendees

Anticipated arrival/departure dates

Percentage of non-local attendees

Double versus single occupancy

Determine whether reservations will be made by rooming list, or individual call in

Determine who is responsible for payment

Refer to Venue Contracts checklist for details on negotiating room rate

Finalize lodging contract and obtain group code

Pre-Event:

Publish reservation cut-off date on all printed materials (one week prior to actual cut-off)

Review block and reduce/increase as needed, and/or adjust shoulder blocks (e.g. dates immediately before or alter the Seminar)

Provide information to attendees regarding all modes of reservations—phone, fax, website, e-mail, internet, mail—as well as reservation number, cut-off date, group rate and group code

Keep detailed pickup reports and reservation data

Determine whether overflow hotel(s) are needed. If so, book accordingly

Specify blocks for sponsors, VIP's and staff

Designate billing

Upgrades

Early check-in

Work with the hotels to have a complete and accurate rooming list before the meeting

On-Site:

Meet with hotel to review any changes

Obtain last minute pick up reports

Determine number of daily no-shows and walk-ins

Research which hotels have overflow availability for last minute attendees (if rooms are tight)

Set-up housing desk or office where attendees can go to ask questions

Go over reservations for VIP's, speakers, staff and others who need to be specially billed

Hold daily meeting with hotel to cover any potential problems

Post-Event
Post-con report
Final pick-up of rooms
Final pick-up of complimentary and staff rooms
Attrition report (if applicable)
Follow-up on comp rooms
Follow-up on commissions
Reconcile bill against your rooming list

Meeting Room Set-Up—Audio/Visual:

Pre-event Logistics

Day/Date

Name of Function

Start and end time of each function

Location of each function

Presenter name

Number of anticipated attendees

Meeting space and presenter stage set up needs

Type of room set-up

Classroom

Theatre

Rounds

Crescent

Hollow square

U-Shaped

Seminar

Presenter staging needs

Risers

Presentation table

Stool

Podium

Audiovisual Needs
Pipe and drape
Screen
Overhead projector
Flip chart
TV and/or VCR
Audio and/or VCR
Computer
Internet access/phone line
Sound system/microphones
Lighting
Back-up generator
Extension cord and/or power strip
Technical support

Consider other functions that may require audiovisual (receptions, parties, board meetings, etc.) and include this information in your Matrix

Audiovisual Vendor Selection:

Identify potential vendors and suppliers (if not required to use in-house AV)

Send Out Request for Proposal Including:
Budget
Master spreadsheet or Meeting Space Matrix of your needs
Request for company history and references
Breakdown of all labor costs
Cancellation policy
Clarification on what costs vendor will-pay for (i.e. riggings, power, genie lifts, etc.)
Final pricing

Receive Proposals and Consider the Following in Your Review:
Price
Technical support and labor costs
Familiarity with selected venue
Ability to handle last minute changes and requests
References

Negotiate pricing

Select vendor

Review and sign contract

Pre-Event Audiovisual Responsibilities:
Keep vendor in the loop on any changes to the agenda or master Meeting Space Matrix
Prepare scripts for general sessions functions and pass along to audiovisual vendor
If necessary, provide vendor with the general session presentations in advance of Seminar to ensure compatibility with systems
Set up on-site rehearsal and testing times
Verify delivery and set-up schedule
Give a copy of the master Meeting Space Matrix to venue technician

On-Site Logistics

Meet with Audiovisual vendor and their team to review master audiovisual spreadsheet with changes and additions

Meet with venue set up crew to review meeting space needs and expectations

Set up communication method (i.e. walkie talkies, cell phones) with critical contacts

Conduct a complete walk-though of venue with audiovisual techs and venue set-up manager to ensure they are clear on needs and locations of each function

Include audiovisual vendor, the venue electrician, engineer and AV technician in the pre-Seminar meeting

Determine emergency procedures in case additional or replacement equipment is needed, or room sets need to be changed

Hold general session rehearsals, reviewing scripts, testing lighting, and adding music and video

Cheek breakout rooms prior to each session to ensure proper audiovisual is in place

Supervise audiovisual vendor on-site

Problem—solve as

Food & Beverage

Determine Food and Beverage Needs:

Based on the agenda, determine the number of food and/or beverage functions

Look at evaluation forms or history of the Seminar to better plan food and beverage

Determine budget for food and beverage

Plan on appropriate time and place of each meal function, based on the agenda

Figure out the estimated attendance at each meal or function, including entertainment, staff and last minute additions

Determine whether food and beverage services will be provided by the venue or by an outside vendor

Outline menu options for each meal, taking into consideration:

Group demographics (age, ethnicity, lifestyle, etc) Seminar theme

Variety throughout the Seminar

Regional or special items that can be ordered

Dietary requirements or limitations

Identify the type of service needed for each meal:

Buffet

Plated

Passed

Reception

Determine how the bar will be organized:
Which functions will include bar service
If drink tickets will be used, how will they be distributed, and how can extras be purchased
Take into considerations the site, sponsor and group's policy on alcohol
What will be served (beer & wine, full bar, specialty drinks, etc)?
Timing of service
How many drinks each attendee is estimated to consume
Insurance and liability considerations
Cash or hosted bar, open bar or limited selection
Review the menu selections and submit for approval, if necessary
Provide the venue with a list of people authorized to make changes to the food and beverage and approval the orders

Review the menu selections and submit for approval, if necessary

Provide the venue with a list of people authorized to make changes to the food and beverage and approve the orders

Schedule deadline dates for food and beverage guarantees

Discuss alternative arrangements for outdoor functions in case whether problems arise

Coordinate, the set-up and flow for each meal or function, taking into consideration:

Assigned seating

Special areas

Preferences

Objective of program or function

Audiovisual

Décor

Table setting

Lighting

Entertainment

Speakers during the meal

Timing of service

Script for event

Ask to sign off on Banquet Ticket following each function while on-site. Don't rely on memory.

Negotiating Tips:

Reduce quantity by 20% for breakfasts (unless history dictates differently)

Ask for food and beverage to be refreshed only at your request

Look at attendance history day by day

Reduce quantities as the Seminar nears the end

Don't place a guarantee until the deadline (quantities can typically be increased after the guarantee—but not decreased)

Customize the menus by eliminating or swapping items

Decrease buffet and salads by 20-25%

Select a la carta items versus ordering full breakfast packages to save money

Serve the lunch dessert at the afternoon break

Offer pitches of lemonade and iced tea instead of sodas

Ask that liquor bottles be opened only as needed and on request

Limit bar service hours

Close bar at the designated time

Ask your hotel contact what the percentage over the guarantee the venue plans for then adjust your numbers accordingly

Discuss how “fixed” the printed menus and costs are and reduce when possible

Understand policies on taxes, gratuities, service charges, cancellation and reduction

Entertainment

Selecting Entertainment Vendor:
Determine your budget
Identify when/where entertainment will be needed
Brainstorm entertainment options as they relate to the theme and functions.
Consider:
The type of entertainment that is appropriate and relates best to the event
The type of entertainment that relates best to the participants
Contact the venue to determine whether they have any in-house entertainment that would be appropriate
Ask venue contact and local CVB (Convention and Visitors Bureau) for recommendations on potential talent
Research nearby attractions and entertainment options
Obtain audio and/or video samples of entertainment
If possible, attend a live performance to preview entertainment

Hiring Entertainment Vendor:
Obtain pricing and proposals
Check References
Select vendor
Negotiate payment and terms

Review Contract and Watch For:
Cancellation policy
Equipment rider
Travel and/or transportation needs and who provides or pays
Personal requirements/needs
Decide on a back-up option in case the entertainment cancels

Pre-Event Planning:

Provide vendor with information on the Seminar theme and participant demographics so they can customize their presentation as appropriate

Determine stage set-up needs

Handle transportation arrangements if necessary

Arrange for entertainer refreshments, food, and amenities

Schedule entertainment rehearsal time and space, and final sound cheek

Determine whose responsibility it is to set-up and teardown equipment

Verify arrangements two weeks prior to Seminar

On-Site
Assign staff member to oversee the entertainment and provide on-site support
Hold rehearsals and sound checks
Have a photographer visually record your event

Décor

Outlining Décor Budget and Needs

Determine décor budget

Decide when and where décor is needed

Stage

Banquet and Dining Tables

Meeting Rooms

Special events

Entrances

Brainstorm types of décor which will enhance your theme

Props—perimeter décor

Balloons

Confetti

Murals

Entrance treatments

Stage displays

Dance floor

Special lighting

Podium

Centerpieces

Linens/chair covers

Candles

Flowers

Plants

Hiring and Working with Décor Vendor:
Identify potential vendors and suppliers
Send Request for Proposal including budget, needs and theme
Receive and review proposals
Check references
Negotiate pricing
Select vendor
Review and sign contract
Verily arrangements 2 weeks prior to event
Verify delivery, set-up and pick-up times
Pay vendor for services

Transportation

Air Travel:

Determine air-travel budget

Decide whether you will work with a travel agency or directly with the airlines

Determine which airlines serve the destination city

Find out if visas and passports are needed for travel

Consider the number of tickets and origination cities that will be covered
Negotiate contracts (or have your travel agency do so) with the airlines. Here are a few items to negotiate when creating a group travel contract:
Reduction in fares
Complimentary seat upgrades
Productivity awards (for example, one free ticket for every 40 purchased)
Complimentary she inspection tickets for planning trip
Guaranteed seat assignment
In-flight coupons for free movies and drinks

Obtain specific instructions on how to use the discount information or codes

Obtain the reservation process and requirements for attendees, and include in the registration materials. Include codes for discounts, web sites, phone numbers to call and deadlines

Be sure to obtain VIP and presenter travel plans if you are not making them

To book VIP, presenter and staff arrangements, do so as far in advance as possible:

Contact VIP's, speakers and staff to determine flight preferences

Obtain arrival and departure dates and preferred times

Tentatively book travel

Have travelers approve the itinerary

Finalize booking

Send final tickets or email electronic tickets to travelers

After event, follow-up on negotiated agreement and obtain free tickets earned

Ground Transportation:

Airport Transfer:
Estimate the distance and travel time between the airport and the Seminar site
Find out if the Seminar site provides complimentary transportation to and from the airport. If so, provide attendees with the drop off and pick-p locations, schedule, phone number and route in the registration materials and reservation information.
Provide attendees with alternative transportation information, including cabs, limousines, public transportation, car rental and on-site parking. Be sure to include phone numbers, schedules, fees, acceptable methods or payment and routes.

Intro-Event Transportation:

Decide what your needs are for intro-event transportation

Determine budget

Figure out how many people will need to be transported

Create a schedule of arrival and departure times and locations

Determine the best roundtrip route to the destination

Use the guidelines below for hiring and selecting your vendor

Hiring and Coordinating Transportation Company:
Determine ground transportation budget
Research options (obtain references from hotel and Convention and Visitor's Bureau)
Create and send a Request for Proposal to include the following

General information and history of organization

Outline of transportation needs including tentative number of attendees, number of pick-ups and drop-offs, locations, dates, times, etc.

Request on overview of fleet to include:

Request an overview of fleet to include:

How many vehicles do they have in fleet?

Do the vehicles have working microphones?

What is the condition and age of the vehicles to be used?

What is the capacity of each vehicle?

What do the vehicles offer (air conditioning, restrooms, etc)?

Can the vehicles accommodate disabled riders?

Other questions to include:

Is the company bonded?

What is the track record and safety record of the company?

Are references available?

Does the company have insurance coverage?

Does the company have all appropriate licenses?

How are costs determined? What are costs?

What is the cancellation policy?

Are the drivers uniformed?

Is there a contact available 24 hours a day, or in case of emergency?

Will there be an attendant on board?

What are the limits or rules of the company for serving food and beverage?

Will passengers be able to leave valuables, on the board if they depart for an event?
Obtain responses to proposal and bids
Negotiate fee
Select vendor
Finalize contract
Create an arrival/departure manifest and send it to the vendor
Determine the best schedule
Receive and approve final schedule
Determine meet and greet arrangements
Exchange contact information with the vendor during shuttle operation
Make any arrangements for sinage on shuttles and at pick-up and drop off points
Arrange drop off location at venue
Organize master billing and gratuities

Activities

Determine What Activities Will Be Planned During the Seminar

Select the types of activities yon will plan:

Group activities as part of the agenda

Optional activities

Team building

Add-on (extra fee)

Spouse-only

Children's activities

Research ideas for the activities, for example:

Golf

Tennis

Swimming

Spa

Local attractions, tours and sights

Shopping

Sporting events

Local shows, theatre, and festivals

Gambling

Discos, clubs and lounges

Restaurant outings and group meals

Boating/Sailing

Fishing

Water skiing

Snorkeling or scuba diving

Walking and hiking paths

Biking

Horseback riding

Skiing, snowboarding, ice skating and other winter sports

Card games and board games

Shuffle board

Video games

Look at what activities have been provided in the past and what attendees will be interested in based on demographics and Seminar theme

Determine the budget for activities

Look at when the activity is to be held and how long it will last

Decide if alternative activities will be scheduled and available

Finalize activities and determine when and where they will be held

Select and Hire Vendors:
Research option
Obtain materials
Compare prices
Negotiate group rate
Check references
Check reservation and cancellation policy
Sign contract
Set-up billing
Make arrangements for food arid beverage during the activities
Book transportation (be sure to include travel time in you plans)
Arrange for entertainment, if necessary
Book professionals for any lessons to be provided
Organize any contests or tournaments that will be held, including prizes and awards
Determine how people will register for the activities, and if confirmations will be sent
Include activities fees, transportation and other information on registration and Seminar materials

Gifts & Awards

Determine the types of gifts and awards needed:

Attendee

VIP

Presenter

Sponsor

Award winner

Contest

Drawing

Door prize

Pillow or room gift

Look at various ideas for gifts and awards:

Apparel (e.g. shirts, hats, jackets)

Bags, totes, backpacks, luggage and briefcases

Binders and portfolios

Calendars and clipboards

Pens, pencils, paper and other writing supplies

Disposable cameras

Alcohol

Gift baskets

Food items

Locally-made products

Bottled water with special labels

Mugs, sports bottles, glasses, cups and cup holders

Clips and pins

Computer accessories such as mouse pads aid CD holders

Calculators, clocks, watches, radios and flashlights

Travel and first-aid kits

Items that relate to the event's theme

Sporting items like golf balls, tennis balls and Frisbees

Music—CD's and tapes

Games, toys and puzzles

Gift certificates

Certificate of donations to relevant charity or local organization

Find out what has been given out in the past

Determine the budget for gifts and awards

Check for any restrictions for gift-giving from both the client and venue

Make decisions on quantities

Do research, price comparison and check vendor references

Select and order the gifts and awards

Provide logos and personalization

Decide when and where the gifts and awards will be distributed

Decide how any requests for additional gifts will be handled

Package or wrap gifts/awards if necessary

Verify shipment and arrival of gifts and -awards

Program, Handouts & Signage

Seminar Program:

Determine who is responsible for providing the content of the Seminar program

Hold a meeting with ail critical players to layout Seminar program contents

Typical Seminar program contents will include:

Welcome letter

Final agenda with times and locations

At a glance schedule

List of highlighted special events or features

Optical tours and add-on activities

List of presenters with biographies

Information on entertainers or special guests

Acknowledgement of special contributors and sponsors

Sponsor/exhibitor advertising

Make a decision as to how the program will be presented:

Book or binder

CD-ROM

Individual handouts in folder

Set deadline for the receipt of final program content/copy

Carefully proofread Seminar program prior to printing

Request printing bids

Select vendor

Manage print deadlines

Finalize shipping arrangements

Session Handouts:

Determine what format the session, handouts will be designed in:

Book/binder

Individual handouts

CD-ROM

Determine who will be responsible for creating-and duplicating session handouts

If presenter will be responsible, provide them with guidelines in terms of your expectations:

Format

Maximize size

Number of copies

Deadline

If your organization will be responsible, have your presenters send you their final handouts in plenty of lime to duplicate. Duplication time will depend upon chosen format

Decide how and when the handouts will be distributed:
Distributed at registration
Handed out in session rooms

Create a policy for dealing with requests for additional handouts (e.g. available upon request following the Seminar)

Sinage

Determine sinage needs:

Sessions

Directional

Registration

Meals

Special events

Table tents

Name plates

Podium and stage

Transportation

Sponsor acknowledgement

Consider the following:

Size

Display options (mounting, hanging, easel, etc.)

Budget

Color

Site restrictions

Shipping—to and from site

Sponsor acknowledgement

Logos

Reusability
Determine whether you will create signs in-house or hire a graphic artist
Obtain signage bids from potential graphic artists and printing vendors
Select vendors
Create clear outline of needs and provide to vendors for design and printing
Proof signage prior to final printing
Handle shipping arrangements to venue

The Final Stretch

On-Site Staffing

Review your on-site stalling needs and ensure a staff member or volunteer has been assigned appropriately. Staffing might include:

Planner team

Registration team

Office coverage

Information counter/booth

Greeters

Room monitors

Floaters/runners

Meet with your staff to review schedules, responsibilities, on-site decision-making and expectations

Final Run Through

Final Verification Calls:

Venue contact

Banquets contact

Audiovisual technician

Entertainment

Décor

Activities

Transportation

Keynote presenters

Registration staffing

Equipment suppliers

Planner Packing List:

Seminar planning binder

On-site

Venue banquet event orders

Meeting space specification sheets and diagrams

Copy of all shipments

Master of event program and handouts

Rooming list

Venue contract

Copies of all vendor contracts

Contact list of all key players

Cell phone

Business cards

Paper/pen

Packing and Shipping:
Acquire or purchase appropriate packing materials (boxes, tape, etc.)
Determine the shipping method you will use
Determine how many days in advance your materials can and should, arrive
Establish deadlines for shipping materials, supplies, signage, etc.
Investigate any policies or storage fees involved with shipping to the venue
Determine whether the venue requires you to use custom shipping labels
Research any customs or international issues if you are shipping abroad
Have your materials insured
Obtain accurate address and content information for shipping and receiving
Create a consistent labeling method and make sure, boxes are clearly marked
Mark your boxes “1 of 20” (or whatever appropriate total number is) and create a shipping manliest, which details box numbers and their contents. This way, if any boxes are missing, you will be able to easily establish the contents
Ask for confirmation that your materials have arrived
Once on-site, identify the storage, location, identify each box against your shipping manifest, and make arrangements for the boxes to be delivered to the appropriate location
Consider storing or saving shipping boxes to use at the end of the Seminar

On-Site Registration

Locate all boxes with supplies

Distribute supplies to either the staff office or the registration area

Set up registration area

Ensure registration counters and signage are placed as requested

Oversee the installation of computers, printers, software and telephone/internet lines

Test all equipment

Place badges alphabetically into holders and place behind registration

Put out welcome packets, giveaways and name badges in registration area

Organize each registration station with supplies

Set up back up procedures in case of system failure:

Manual cheek-in of attendees

Use of badge template on word document for badge corrections

Manual credit card processing

Run any badges for attendees who have registered after badges were printed

Train registration staff on registration processing including check-in of pre-registered attendees, walk-in registration, badge corrections, staff, press, VIP and speaker check-in, payment application, customer service, etc.

Obtain cash bag for supervisor

On-Site Attendee Registration:

Ensure you have an on-site supervisor at the registration area at all times

Ensure staff processes all attendees correctly

Distribute name badges, giveaways and welcome packets for pre-registered attendees and walk-ins

Ensure payments are applied correctly and money reconciled

Reprint badges as needed

Apply payments on-site

Run reporting and registration counts as needed

Supervise registration staff and send on breaks as needed

Problem—solve any attendee issues

On-site Breakdown:

Handle breakdown of registration area and staff office

Oversee breakdown of computer equipment

Return all unused materials, equipment and reports

Follow-Up:

Ensure all payments received on-site are input into the system

Input all walk-in registrations (if they were not input on-site)

Check in ail attendees from manual attendee lists, so a final count can be made

Create final reporting

Handle any collection efforts from unpaid attendees

On-Site Management & Pre-Seminar Meeting

On-Site, Logistics: Prior To Start of Seminar

Arrive at least two days prior to the seminar to handle any pre-event coordination

Walk through the venue and locate
Session rooms
Registration area
Office
Supply room
Business Center and/or office supply store
Nearest pay telephone and house phone
Restrooms
Cash machine

Identify and introduce yourself to outsourced and venue staff you have not met

Check on any VIP arrangements

Locate, have delivered and unpack any materials shipped to the venue

Setup the registration area (see On-site Registration Checklist)

Conduct staff orientation and training, if necessary

Supervise set-up of A/V, meeting room arrangements and décor

Schedule speaker rehearsals

Check Seminar signage accuracy of information and proper placement Conduct pre-con meeting w/ venue staff and key players

The Pre-Seminar Meetings:

The pre-Seminar meeting (pre-con) is conducted on-site by the venue staff responsible for the execution of the Seminar. The pre-conf usually takes place a day or two before the event, and will cover all of the event details in-depth.

In order to create the event resume, which includes the details of the entire event, the venue will need to have received the following from you prior to the per-con:

Final agenda

Description of the Seminar, audience and host group

Updated rooming list, including:

List of who should be placed in comp rooms

Billing information, including who pays for lodging, fax and incidentals

VIP arrival/departure dates and times

Amenity deliveries

Food and beverage selections, detailing set-up and serving time, plus initial guarantee

Audiovisual needs

List of authorized decision makers and approved signers to the master account

Security needs

Transportation needs

Shipping and receiving plans

Banners and signage information

Hours of operation for registration area and/or your office

The Pre-Conf will Typically be Attended By:
Seminar planner
Convention Services Manager
Registration supervisor
Critical vendors, such as transportation, decorators and production company
Reservations
Housekeeping
Front Desk and Bell Stand
Banquets
Audiovisual

Things to Bring to the Pre-Con:
Meeting planner's kit
Any last minute questions
Business cards
Contact information for yourself during the Seminar (cell phone or pager numbers are very helpful)
List of final changes

At the Pre-Con, You Can Expect:
Introductions
Overviews of the Seminar, host organization and agenda
Review of the Seminar resume
Final changes
Exchange of contact information
Detailed review of plans day-by-day with convention services, catering and audiovisual

On-Site Logistics: During Seminar:

Place signage each day and ensure hotel reader boards are accurate

Check room set-ups to ensure they have been set per your request

Check all audiovisual equipment to make sure it is working properly

Check room temperatures—adjust if necessary

View the meeting rooms through the eyes of an attendee. Can they see and hear, and are they comfortable?

Ensure all décor and food and beverage are delivered on time and consist of selected items

Review and sign banquet checks at the end of each break or meal

Verify that arrangements are in place for the next meal, session, activity, etc.

Conduct staff and client briefings

Troubleshoot any situations as they arise

Make a list of service issues, complaints and concerns for later negotiations and post-Seminar meetings

Distribute and collect evaluations

Review daily lodging no-show and pick-up lists from the venue

Sign off on audiovisual each day

On-Site Logistics: Following the Seminar:

Conduct or schedule a post-Seminar meeting with the venue and client

At the end of the Seminar, collect any materials you wish to save

Pack and ship materials

Check in with venue contact before your depart

Handle any vendor and staff tipping

Tips on Tipping:

Be clear on venue's policy on tipping. Understand who the recipients are of any contracted gratuities and service fees

Consider Giving Gratuities or Bonuses to:
Banquet and bar staff
Concierge, front desk and bell staff
Audiovisual technicians
Housekeeping
Shipping and receiving staff
Convention Services Manager or key on-site contact
If you wish to tip individuals who are particularly helpful to you, start a list by writing down the names and departments of those people. At the end of the Seminar, assign a dollar amount per person based on your budget. You can then hand out gratuities to those staff that made your life easier on-site.
Request a cash advance against your master bill for gratuities
Ask the venue to provide you with blank note cards if you have time to write handwritten notes to the recipients
You may also consider giving leftover T-shirts, tote bags or other goodies from the Seminar instead of cash
Distribute the results to the appropriate people, who might include:
Presenters
Sponsors
Attendees
Venue
Vendors
Staff

Evaluation Content Should Include:

Name and contact information

Overall evaluation of the Seminar

East of the registration process

Appropriateness of length and time of the Seminar

Most valuable/least valuable aspects

Seminar materials

Call for suggested topics, speakers or sites for future Seminars

Marketing research questions

Specific Presenter Feedback, Such As:

Content and relevancy

Instructors knowledge of subject

Presentations

Materials

Length of presentation

Value of session

If they would recommend the presenter

Logistics:

Venue

Lodging

Food and Beverage

Activities

Special Events

Bill Verification

Establish well ahead of time the billing information, including who pays for lodging, fax and incidentals of the attendees

Set up master account

Give the venue a list of people authorized to sign charges to the master account

Set-up a daily appointment on-site with the accounting contact to review charges, address concerns and have an overview of your master bill

Keep a copy of all signed orders and documentation

Reconcile the final bill when it arrives mid review it carefully to make sure it correct reflects;

All previously—reviewed and contracted charges

Only the event and group you are responsible for

Appropriate head counts and group guarantees

Lodging charges

Food and beverage

Audiovisual

Shipping or storage fees

Business Center charges

Meeting room rental

Inadvertent charges made by attendees

Any additional audiovisual and food and beverage orders

Complimentary rooms

Any previously negotiated items like discounts on audiovisual or food and beverage

State and local taxes

Deposits

Service charges/gratuity

Parking
Use the guidelines above to settle any vendor bills as well
Follow up on any inconsistencies in the billing
Request final and revised bills
Request commission payment as soon as bill is paid
Keep records of ail payments made
Enter final figures into a Budget To Actual spreadsheet to determine whether you achieved your budgeted goals

Evaluations

Planning for Evaluations:
If evaluations have been used in the past, look, at the historical methods and results
Outline why you are planning to provide evaluations and what purpose the information obtained will serve.
Determine what will be evaluated. Consider creating separate evaluations (or sections within the evaluation form) asking for feedback on:
Sessions
Presenters
Special events and activities
Location and venue
Accommodations
Meals and receptions
Decide who will be responsible for drafting, distributing, collecting and tabulating the evaluation forms
Decide which evaluation methods will, be used (e.g., on-site, scanned, internet, mail-in)
Decide when and how evaluations will be distributed, collected arid tabulated
Response rates are significantly higher if you collect evaluations on-site.
Consider the following methods of encouraging and increasing response:
Offer door prizes or incentives
Make announcements
Post signs clearly showing where to return evaluations
Assign a person to collect evaluations as people leave the meeting room
Create the evaluation forms
Proofread the forms carefully, and obtain vendor approval if necessary
Print and ship evaluations
Once on-site, distribute and collect the evaluations
Tabulate the results, scanning the evaluations for testimonials that can be used for future marketing materials
Establish the final format of your analysis (e.g., spreadsheet, overview of presentation)

Marketing Strategies

As discussed above, (in one implementation) the marketing module 104 presents a plurality of different marketing strategies to a user (along with a tutorial of each strategy). Table 1 below includes sample strategies for marketing an event that can be provided to a user through the marketing module 104.

| Strategy | Description |
|---|---|
| $1 Million Dollar Bill | People love money, so print up a $1 Million Dollar Bill, and |
| Strategy | have a sales letter written on the back and get people to call a |
| | Toll Free 24 Hour Hotline Number or offer a free report, |
| | http://www.atlantaadvertising.com/index.php [Atlanta Bills] |
| | or . . . Brian Maroevich - 1-800-230-5303 x#99 |
| “50,000 Tickets - $150 | Print up 50,000 invitations or flyers. Attend the seminar, |
| Value (Print)” Strategy | workships, and networking events of your target audience, and |
| | give each participant a free ticket. Indicate on each ticket that |
| | the value of each ticket is about $149.00 each; however, give |
| | each ticket away for free. |
| Advertise to Millions and | www.advertisetomillions and www.getwebhits.com |
| Get Web hits | |
| Automate, Integrate, & | An ALL-IN-ONE, STATE-OF-THE-ART, SHOPPING CART/ |
| Simplify Process - Set-up | MARKETING TOOLS SYSTEM EXACTLY LIKE |
| www.1shoppingcart or | 1ShoppingCart.com Why? To succeed online, you'll need a |
| www.constantcontact.com | domain name, a web site, a product or service, a shopping cart, |
| | a merchant account, marketing tools, traffic and training! We |
| | provide all of these through 1ShoppingCart.com and our |
| | affiliate web sites because we are DEDICATED TO YOUR |
| | SUCCESS! CLICK HERE to review our Features & |
| | Economical Packages |
| American Planning | American Planning Association - http:/www.the-dma.org/cgi/mtsearch1?type=CONF |
| Association | |
| Affliate, Super Affliate, | Affiliate Network with tons of exclusive offers no other |
| www.superaffliate.com, | networks have. Earn big money and get paid on time. Lead |
| www.refer-it.com | generation and CPA offers. Earn 10% with our 2nd tier referral |
| | program. |
| ASK LES/ASK ALEX | http://asklesbrown.com/ |
| Mandossian | |
| Attendee List | If you plan on attending an annual conference, guest |
| | sometimes register early. Therefore, you should contact the |
| | seminar organizer and ask them for the list of attendees. You |
| | may have to become a vendor or sponsor, but you may want to |
| | get the attendee list early so you can perform some pre-seminar |
| | marketing. |
| Greg Cesar's Friend - Super | (Affliate, Super Affliate, and Virtual Stakes) - Drop Shipper |
| Affliate Expert | |
| AM2 Gold Coaching | One of the most powerful internet markekting - Mastermind |
| Program | Group in the country |
| Automated Response | Utilize “ART “24 Hour Free Recorded Message” and |
| Technology | “ART “Voice broadcast” to market and promote your services. |
| Assension - Promo DVD | Great Promo DVD's - Great for Marketing your product or |
| | service |
| Attend Chamber Mixers, | Great non-threatening strategy to network, and to market your |
| Socials, and Real Estate | product and services through their mixers, socials, and flyer |
| Networking Meetings | delivery service. Post company on websites |
| Attend National, Regional, | Great strategy for branding, marketing, and product sales |
| and Local Trade Shows and | |
| spread word | |
| B2B Gathering Meetings | Partner with friend Rick Silva and his “Lead” Meetings. |
| Backend, Backend, and | Begin with regular product. Next . . . , upsale clients to |
| Backend again | consulting, bootcamps, trainings material, home study courses, |
| | etc. Janet Switzer's Funnel System is a great resource |
| Bartering and Trading for | Barter for products and services. www.bartercompany.com |
| Services (Marketability and | |
| Jim Rhon's Concept) | |
| Bi-lingual (Advertising | Utilize Bi-lingual (Advertising Mediums) |
| Mediums) | |
| Book, Author, Expert on | Create an e-book, or write a book. Get it published and receive |
| Subject Matter - Amazon | instant Expert Credibility |
| Contact | |
| Bubble Media | Mobile advertising trucks. |
| Business Seminars, Brand | One of the most powerful and effective ways to brand |
| Company w/ up-coming | company, sell products, and market products and services. |
| seminars | Great way for product sampling and customer contact. |
| Buyer's List vs. Mailing | Purchase a Buyer's List versus mailing list. |
| List | |
| Chamber of Commerce | Join; Flyer Delivery; Raffle Products. Great non-threatening |
| | strategy to network, and to market your product and services |
| | through their mixers, socials, and flyer delivery service. Post |
| | company on websites |
| Cherryone.com | Jim @ Cherryone.com |
| Webdesigner (Internet | http://www.cherryoneweb.com/htm/portfolio.htm |
| Conversion) | jim@cherryone.com |
| | Discount - 10% Discount |
| Client Appreciation Dinner | Host a client appreciation day. Invite attendees to bring a |
| or Seminar | friend. |
| CNBC-11 (Janice | Free TV Publicity |
| Edwards) | |
| Consignment | Give tickets to clubs and organizations on consignment. Have |
| | them sale your tickets for a fundraiser. |
| Database “In House List” | Contact customers who have already purchased your products |
| | and services already. |
| Diable Magazine, Trade | Locate Targeted Audience. Post ad, or write story for |
| Journals, and Business | publicity. |
| Magazines (Articles) | |
| Discount booths @ local | Trade Shows are great ways to market products and services |
| Events, Tradeshows, | |
| etc.,(e.g, Kendra Todd, | |
| Donald Trump) | |
| Direct Marketing | http://www.the-dma.org/cgi/mtsearch1?type=CONF |
| Association | |
| DVD Promo | Produce a promo DVD and distribute to audience as a |
| | marketing tool. |
| DriveAd Campaign ($100–$2,500) | Effective way to market products and services. |
| East Bay Business Times | Book of List that I purchased. |
| (Book of List) | |
| Electronic Postcards, | New, fast, economical way to reach audience. |
| Unlimited Sales Leads, and | |
| Mailing List | |
| Elite Leads Meetings | Contact Sharron Abbot; collaborate with people with very |
| | large contacts and databases. |
| E-mail Marketing (e-mail | Jerry Hart of Hart Creative Marketing or Fran Brigges. |
| blast) | |
| E-mail, fax, and direct mail | East Bay Business Times - Executive List |
| blast to East Bay Business | |
| Times Database - 3,000+ ($90) | |
| Exhibitrac (List of Vendors | http://www.tsnn.com/exhibitrac.html Great list of vendors and |
| and Exhibitors) | exhibitors who have large budgets, and who often purchase |
| | vending spots. |
| Fax Blast (98,000 Bay | Create a Powerful Headline, and fax blast to 98,000 Database |
| Area Customers) | ($.03 per fax = $2,940) |
| Flyer Delivery Service | Locate individuals, companies, or services that deliver flyers to |
| | your target audience |
| “Flyers, Posters, and Door | Use “Flyers, Posters, and Door Hangers” to deliver your |
| Hangers” | message. |
| Fran Briggs, Black | Massive e-Media Blitz ($127/$207/$499/$1,750) |
| Business Listing PR, PR | |
| Etcetera | |
| Free e-books, Newsletters, | A must for staying in constant contact with clients. |
| Reports, and Consumer | |
| Reports, e-Zine Articles - | |
| www.Allbusiness.com | |
| Free Tele-seminars - Work | Initiate Tele-seminars. |
| w/ Alex Mondossian | |
| Free Surveys - Market | http://www.freemarketresearch.com/ |
| Research | |
| Fundraising | Have a seminar or workshop. Charge $99–$450. Allow |
| | organizations to sell tickets for a fundraiser. |
| Go to the Big Seminar in | Best Internet Marketing Seminar in the country. |
| L.A. set-up an Affiliate | |
| Program ($1,000–$2,000) | |
| Gorilla Marketing.com | http://www.gorillamarketing.com/resources.html |
| Government Agencies - | Rudy Garcia, from Coloradom 303-582-1955, |
| GSA Certification | www.rudyvgarcia.com, 15 To-17 Years of Consulting, $6,000 |
| | Fee www.gsaadvantage.gov; I need to pursue - MOBIS for |
| | Small Business Consultants“Click Solicitation”www.imt3.com - |
| | Robin Lawton/Int'l Management Technology Firm |
| Grass Root, Street Teams, | Sean Kennedy, and Mr. San Ramon's Son. |
| and HR | |
| Guava Films Signs ($0 - | Elevate and capture the excitement of your event with live |
| Get Sponsor to fund) | video coverage projected “real time” onto large format video |
| | screens. Direct audience attention to your brand, your message, |
| | the speaker, the entertainment or an auction item. Creatively |
| | combined and delivered to your attendees at the appropriate |
| | time. Our Sponsorship model creates value for Sponsors, while |
| | raising funds to offset production costs and underwrite other |
| | event-related expenses. |
| e-Media Blitz | Fran Briggs. Used to do publicity for Oprah. Press Release |
| | Distribution, or e-marketing campaign |
| | ($127/$207/$499/$1,750) |
| HSMAI's Event Planner | http://www.affordablemeetings.com/national/benefits.cfm |
| Conference | [Registration] |
| | http://www.affordablemeetings.com/national/speakers.cfm |
| | [Speakers] |
| Hire a Tele-marketing | Have telemarketing service sale products for you for |
| service or Sales Team to | commission. |
| sell Ads (Commission only - | |
| $0) | |
| Huge Direct Mail | Seminarsuccess.com. |
| Campaign w/ Match Point | |
| Advertising ($1,000–$5,000) | |
| Hungry Crowd Strategy | Hungry Crowd, Hot Leads, Ready to Buy Now Strategy. Use |
| | inventory.overature.com and other websites to find out what |
| | the demand is first. Then . . . , and only then, do you produce |
| | your products. |
| IBI Global Contacts | IBI Global Internet, Weekly Meetings, Bi-monthly Meetings, |
| | and phone directories . . . |
| Infomercials | Utilize www.marketforce.com for inexpensive infomercials |
| Inhouse Database - 80/20 | Focus on internal database. 20% of my opt-in clients usually |
| Rule | purchase 80% of my products and services. Identify these |
| | clients, and keep selling to them. |
| Initiate a Voicemail | *Automatic Marketing Hotline. Your own private “all |
| Broadcast to general | inclusive” Toll Free marketing system, complete with all the |
| database - 2,000+ ($1,000) | tech tools, tracking features and strategies you need to |
| | Generate more leads using Free Recorded Messages, Evaluate |
| | and qualify those leads & Track the effectiveness of your |
| | advertising. *Voice Broadcast System - Enables you to “Voice |
| | Broadcast” recorded messages, announcements, Holiday |
| | Greetings, etc. to the voicemails or answering machines of any |
| | or all of your clients at once. |
| Inner Circle Marketing | The latest - Proven Tactics Used To Double Income And |
| Secrets | Triple Time-Off By “Residualizing” Your Business. Alex |
| | Mandossian is a big player in this game. Players: T. Harv Eker, |
| | John Carlton, Robert Cialdini, Amand Morin, Joe Polish, etc . . . |
| Internet Marketing | Internet marketing strategies. |
| Strategies - Corey Rodl's | |
| (100's of secrets) | |
| Internet Sales Copy | John Carlton's System. Also, |
| | http://www.instantsalesletters.com/resources.html |
| Jim Rohn Strategy (45 | Barter; free 45 minute demonstration; target all Sales and |
| Minute - Free Demo) | Networker Marketing Meetings; Chamber Meetings, etc, . . . |
| Joe Polish Recommends - | Top resources to accerate one's business. |
| DMA Association | |
| John Carlton's System . . . | Best Copy Writer System in addition to Dan Kennedy and Ron |
| | LeGrand's. |
| Join Chamber of | Join all Chamber meetings. Small Business Owners, lots of |
| Commerce (e.g. Concord, | influence, and huge databases. |
| San Ramon, and Walnut | |
| Creek) ($350) | |
| Joint Ventures (Rick Silva, | Partner with these individuals: Rick Silva, Tom Hart, Cesar |
| Tom Hart, Cesar Plata | Plata, Sharon Abbot, National Wealth Builders, Bus Times, |
| Sharon Abbot, National | and IBI |
| Wealth Builders, Bus | |
| Times, and IBI) | |
| KBLCtv - Cable Radio | Contact Madge Gates, Kelvin, and Mariam. Great resources |
| | for public broadcasting TV |
| Katie Brandt (Big Seminar - | http://www.dog-breeds-infosite.com/Katie's Website |
| Great Internet Mrkt | katie@deliverfreedom.com |
| Resource) | www.deliverfreedom.com |
| | www.winningthenamegame.com |
| | www.memorytrainingforstudents.com |
| | Katie Brandt |
| | The Memory Gal |
| | Director of Marketing |
| | Freedom Speakers & Trainers |
| | 2424 American Lane |
| | Madison. WI 53704 |
| | 608-268-2600 ext#103 |
| | 608-268-2607 fax |
| KETH - PBS Television | Call Public Broadcast Station. Offer them products and |
| Auctions | services of value, and let them use your items as a aution item. |
| | In exchange, ask for free TV and media time. Assistance with |
| | auctioning products on quarterly auctions |
| Learning Annex | Attend the Learning Annex Conferences. Have a booth at their |
| | event, or hire a street team to distribute flyers during or after |
| | their event. |
| Market Research - SDR, | Follow Michelle Anton's Strategy - magazines, headlines, and |
| Business Library, | trends. www.consumerreview, www.consumersearch.com |
| Alexa.com, Oprach, Dr. Phil, | www.consumeropinions.com |
| Dateline and Global | |
| Aspect | |
| Market-Ability (Mike | There is an incredible $30 Billion worth of advertising time |
| Hughes. www.market-ability.com) | left unsold each year. This unsold media is sometimes used in |
| | joint ventures to promote products, services, business |
| | opportunities and web sites. Market-ability was created to |
| | make the media accessible to the individual or small business. |
| | Some clients went from zero to $200 million in sales! |
| Media Broker (s) for Cheap | And Allberman - Media Buyer - 30 Min TV Shows, TV, Int'l, |
| Newspaper, Radio, and | Scott Kreiger - Generation Marketing - #801-802-0324. |
| Journal Ads ($2,000) | Mailing Houses. Xievier and someone Cityblue. Heath Kruger |
| | # 603-305-0762. Save time negotiating with hotels |
| Michele Anton's Coaching | Oprah's ex-producer. Sells coaching and opens her database to |
| & Contacts Program | those who partner with her. |
| Mixers and Socials | Obtain list from local Networking clubs and organizations and |
| | Chambers. |
| Muybueno.com (Cecar | Resources from Cesar Plata, mixers, socials, etc . . . |
| Plato) | |
| MMP - The Marketing | Great Program - especially, the MMP Seminar System |
| Maximization Program | Developer |
| Monopolize Your Market | Great strategy for the latest marketing plans, tactics, and |
| Place Strategies | strategies. |
| National Publicity Summit | National Publicity Summit - Bradley Communications Corp. - |
| | 135 East Plumstead Ave - Lansdowne PA 19050-610-259- |
| | 0707 x872-fax 610-284-3704 |
| National Speakers | http://www.abwa.org/ |
| Association & American | http://www.planning.org/2006conference/ |
| Business Women | |
| Association & American | |
| Planning Association | |
| NetSpoke | Utilize this system to conduct internet, powerpoint, and |
| | WebEx sessions. |
| Newgroups and Chat | Important to find out key trends, problems, and opportunities |
| Rooms | to penetrate niche markets. |
| Newsmax.com and | Great example of ads (Killer Salesmanship Letter Ads) |
| jasonpotash.com | |
| Newsletters (Service for | Utilize the Service for Life turn key newsletters for |
| Life) | communicating with your customer. |
| Niche Marketing | Use overature, search engines, interest, hobbies, problems |
| Outsourcing/E-lance | Outsourcing Video. Must do for all businesses. |
| (Outsource Sales, | |
| Customer Support, IT, | |
| Ghostwriting, Editing, | |
| Staffing, etc) | |
| Partner w/ 100 Black Men, | OAM, Contacts, and resources |
| VIP Line-up, CitiFlight, 1st | |
| Friday's, etc . . . ($0) | |
| Partner w/ KBLX, KKIQ, | Contact for discount. Relationships with them. |
| KDYA, & KMEL for | |
| Radio Time | |
| Partner w/ Non-Profit | Easy way to get free media or inexpensive media |
| Organization; donate some | |
| proceeds; Free Media | |
| PSA's (Free) | |
| Partner with groups who | Queen Bee System. Identify the heavy hitters and create |
| have large databases; create | incentives for them. |
| incentives ($0) | |
| Patlive | Go to www.paltive.com to have them answer your phone calls |
| | for your seminar registration. |
| Pay Per Click | http://www.newsday.com/community/ny-quigo-landing.0,3800077.htmlstory |
| Paul Hartunian's Database- | Top system for producing Press Releases, Bio Sheets, and |
| 17,500+ Media Contacts | Q&A sheets. Purchase his database of 17,000 media partners |
| (fax blast) - ($525) | plus the gold disc. |
| People go online for | Understand the sales process on thc internet. Provide free |
| information versus Buying | information and reports. Sale later. |
| | http://www.allbusiness.com/ |
| | http://www.marketingsource.com/articles/ |
| Phranah Marketing | Joe Polish. ELF (Easy, Lucrative, and Fun) or Half Business |
| Stretegies | (Hard, Annoying, Lame, and frustrating) |
| Piggy Back Strategy | Find a large conference or seminar who has your target |
| | audience. For example, The Learning Annex Real Estate |
| | Seminar. Attend their event, and distribute your flyers and |
| | invitations during or the day after their event. If they paid for |
| | marketing and advertising to get that audience in the seats, |
| | simply piggy back off of their marketing and advertising. |
| Preview Seminars | Produce “Preview Public Seminars (Restaurants, Community |
| | Centers, and Hotels).” Hold seminars in regional locations |
| | (e.g. San Francisco, San Jose, Oakland, and San Ramon). |
| | Have events on Tuesday, Wednesday, and Thursday between |
| | 8am–6pm. Charge low fees and tocus on getting lots of |
| | attendees and building your database. Then, upsale more |
| | expensive products and services later. |
| PRWEBMAGIC/LaRose | http://www.prmagic.com/ |
| Group | |
| Publicist | Hire a professional publicist to get media coverage. |
| Non-Profits | PSA's Radio - Partner with Non-profit. Partner with non- |
| | profits. Or, create your own. |
| Publicity, Gold Disc, | Top Publicity websites (free/cheap): Publicity. Gold Disc, |
| PRWEB, PRZOOM, | PRWEB, PRZOOM, PRLEAP, PRNWEWSWIRE, |
| PRLEAP, | BUSINESSWIRE |
| PRNWEWSWIRE, | |
| BUSINESSWIRE | |
| Real Estate Flyer Delivery | Reach all Realtors in Bay Area |
| Service | |
| Real Estate Marketing | There's a meeting in every city in the Tri-Valley Area |
| Meetings | |
| Referral Marketing and | Scott Degraffrenreid - N.U.D.E. Model + Brian Buffini, and |
| Viral Marketing Campaign | David Frey's Instant Referral Systems |
| Richard Schefren - Coach | Great Coach for systems, processes, and profitability. |
| Rick Silva, Topy Brink, | Partner w/ them. |
| Cesar P., Mike Hughes, | |
| Sharyn Abbot, etc . . . | |
| Rod Lockett | Event Pix - 800.743.4153 ($2,000–$&000). Great service for |
| | taking photos and surveys. |
| Ryze Meetings | Find meetings and attend. |
| Sales Copy | Go to websites like: |
| | http://www.ultimatemarketingminisites.com/ |
| | Have a master sales copy writer write your sales letters, and |
| | place them on your website. |
| Secret Associations, Rotary | Identify and join |
| Clubs, and Contacts | |
| Seminar Direct/Seminar | Seminar Direct “The Seminar Marketing System” (888) 629–1919 - |
| Success | seminardirect.com/or seminarsuccess.com |
| Seminar Catalog | Produce an online Seminar Catalog (e.g. Fred Pryor, |
| | HSAIM, Learning Annex).” List all upcoming seminars and |
| | workshops. |
| www.Sellmorebooks.com | 619-582-1221 @ www.sellmorebooks.com |
| Send Press Release to | Send to Toni, and she distributes to 7,000 3 times a month |
| PRetcetera (Toni Becken) | |
| to 7,000+ Bay Area | |
| Contacts ($300) | |
| Send Press Release to | |
| PRetcetera (Toni Becken) | |
| to 7,000+ Bay Area | |
| Contacts ($300) | |
| Share my personal Seminar | Internal Database (Team in Fremont, and Design by 6 |
| Database from past three | database) |
| seminars - 2,000+ ($0) | |
| Sponsorship | Sponsorship.com: ieg., and Sponsorwise.com |
| SDR Research Media | SDR Rpt |
| Report | |
| Speakers | Partner with Speakers with large databases. (Large Databases/ |
| | Hometown Heros) |
| Steven Pierce, Teddy, Ty, | Great Resources for EastCoast Connection |
| Cesar Mastermind Group | |
| Market Research | Internet Marketing System.http://www.stevenlive.com/15.doc |
| | Nov. 15, 2005 |
| | Stephen Pierce, All rights reserved. |
| | to get your Market Research Process Map please go to |
| | http://www.smartmarketingcoachingclub.com/accel/research-map.pdf |
| | To get your Criteria Matrix worksheet, please go to |
| | http://www.smartmarketingcoachinclub.com/accel/criteria.pdf; |
| | To get a mind map of today's session, please go to |
| | http://www.smartmarketingcoachingclub.com/accel/rstp-mindmap.pdf |
| | Find Out What's Really HOT! - http://buzz.yahoo.com/ |
| | http://50.lycos.com/ |
| | http://www.google.com/press/zeitgeist.html - |
| | http://hot.aol.com/hot/hot |
| | http://www.dogpile.com/info.dogpl/searchspy/ - |
| | http://www.imagine-msn.com/insider/ |
| | Top 9 Consumer Magazines Ranked by Circulation |
| | AARP Magazine http://www.aarpmedia.org/home.php |
| | Reader's Digest http://www.rd.com/ |
| | TV Guide http://www.tvguide.com/default |
| | Better Homes and Gardens http://www.bhg.com/ |
| | National Geographic Magazine |
| | http://www.nationalgeographic.com/ |
| | Good Housekeeping http://www.goodhousekeeping.com/ |
| | Family Circle |
| | http://www.familycircle.com/home/homepage.jsp |
| | Ladies' Home Journal http://www.lhj.com/ |
| | Woman's Day http://www.womansday.com/ |
| | Check the Bestsellers List |
| | Look at the Amazon.com “Bestsellers” in each category |
| | Look at the NY Times Bestsellers list |
| | http://www.nytimes.com/pages/books/bestseller/ |
| | Look at the Wall Street Journal Bestsellers list |
| | http://www.cnn.com/books/bestsellers/ |
| | Once you have thought starters go to . . . |
| | http://inventory.overture.com/d/searchinventory/suggestion/ |
| Street Teams | Hire street teams to distribute your flyers |
| Target Local Magazines, | List from Magic Folder and Channel 4 |
| Newspapers, and Financial | |
| Institutions ($1,000) | |
| Target Local | Grass Root Marketing |
| Organization, Churches, | |
| Promotion Agencies, | |
| Promotion Directors, etc. | |
| Teleseminars | Alex Mandossian, Stephen Pierce, Christopher Guerra |
| Telemarketing Servies | Identify and join |
| Trade Shows & Vendor | Identify and join. Go to |
| Booths | http://www.biztradeshows.com/usa/usa-tradeshows.mp?month=april |
| | or www.theadventure.com and |
| | utilize these tradeshow strategies and tactics. |
| Tri-Valley Convention and | www.wacvb.com - List all clubs in country. |
| Visitor's Guide | |
| Ultimatemarketingminisites - | Dave Mizrachi - 954-290-7418 - 8am–5pm EST only call |
| Dave Masrosi | |
| (webdesigner) | |
| Website (Standard) | Regular website |
| Viral Marketing | |
| Voicemail Broadcasting | Automate Response Technologies - Phone: 1-888-408-4222 |
| | ext.9009/Fax: 949-498-2591: 1150 Calle Cordillera suite B, |
| | San Clemente, CA 92673 How To Deliver Your Compelling |
| | Sales Message For Virtually Pennies! Use ART to send out |
| | personal sounding voiceblasts to your entire database. Your |
| | customers will think you picked up the phone and called them |
| | personally . . . and it costs practically nothing! |
| Wine & Cheese | Attend Wine & Cheese Festivals, Community Jazz Concerts, |
| | and other festivals and events. Many of the people at these |
| | events are very affluent, and it's good to brand your message to |
| | events that people are passionate about. |
| Widen Market: Latino, | Get Translator and Partner with other Global and Ethnic |
| Asian, European, | Leader and Organizations. |
| Canadian, etc | |
| WWW.Buzz.com Use | www.buzz.com |
| these websites | |
| Consumer Research and | www.consumerreview, www.consumersearch.com, |
| Demographics | www.consumeropinions.com |
| Yellowpages.com | Advertise online yellow pages using Joe Pollishes examples - |
| | http://www.yellowpages.com/sp/?_requestid=3999187 |
| Zairmail | Great Resource - Zairmail Express Direct |
| | Internet Direct Mail Service |

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection, with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD,

Various implementations of a event management and marketing system have been described. Nevertheless, various modifications may be made to the implementations, and those modifications would be within the scope of the present invention. Accordingly, many modifications may be made without departing from the scope of the present invention.

What is claimed is:

1. An event management and marketing system comprising:
a planning module to receive user input entering a name of an event; and
a marketing module to
present to the user a plurality of different marketing strategies for marketing the event;
receive user input selecting one or more of the of different marketing strategies; and
generate an output corresponding, to each marketing strategy selected by the user, each respective output to be used in execution of the corresponding marketing strategy.

2. The event management and marketing system of claim 1, wherein the marketing module is further operable to provide a tutorial to the user, the tutorial including information corresponding to each marketing strategy.

3. The event management and marketing system of claim 2, wherein the output is in a form of at least one of a plan of execution, an e-mail, an advertisement, an admission ticket.

4. The event management and marketing system of claim 2, further comprising a fundraising module to provide a plurality of different fundraising strategies to the user for raising capital to fund the event.

5. The event management and marketing system of claim 1, wherein the planning module warns the user of calendar days to avoid scheduling an event.

6. The event management and marketing system of claim 1, wherein the planning module is operable to maintain a weather outlook for days during which the event is planned.

7. A computer program product, tangibly stored on a computer-readable medium, for marketing an event, the product containing instructions for causing a programmable processor to:
receive user input entering a name of an event;
present to the user a plurality of different marketing strategies for marketing the event;
receive user input selecting one or more of the of different marketing strategies; and
generate an output corresponding to each marketing strategy selected by the user, each respective output to be used in execution of the corresponding marketing strategy.

8. The computer program product of claim 7, further comprising instructions to provide a tutorial to the user, the tutorial including information corresponding to each marketing strategy.
